(19) United States
(12) Patent Application Publication
(10) Pub. No.: US 2026/0021443 A1
(43) Pub. Date: Jan. 22, 2026

(54) SYSTEMS AND METHODS FOR SEQUESTERING CARBON DIOXIDE AND NEUTRALIZING ACIDIFICATION OF NATURAL WATER BODIES

(71) Applicant: Knudsen Holdings LLC, Cape Elizabeth, ME (US)

(72) Inventors: Matthew Jordan ODLIN, Freeport, ME (US); Justin Baker RIES, Swampscott, MA (US); Max CHALFIN, New York, NY (US)

(21) Appl. No.: 19/064,347

(22) Filed: Feb. 26, 2025

Related U.S. Application Data
(63) Continuation of application No. PCT/US2023/073052, filed on Aug. 29, 2023.
(60) Provisional application No. 63/401,959, filed on Aug. 29, 2022.

(51) Int. Cl. B01D 53/14; C02F 1/28; C02F 1/66

(52) U.S. Cl. CPC B01D 53/1475; C02F 1/28; C02F 1/66; B01D 2257/504

(57) ABSTRACT

A method includes deploying a payload at a first location in a body of water while the payload is in a first configuration. The payload can travel via natural water currents to a second location in the body of water and transition from the first configuration to a second configuration during travel from the first location to the second location to facilitate atmospheric carbon sequestration. The method includes quantifying an amount of the atmospheric carbon sequestration associated with the payload transitioning from the first configuration to the second configuration. In some implementations, the payload may be a substrate that may be seeded with a target product. In some implementations, such a substrate may be formed of naturally occurring material, which may include an alkaline liquid.

### CROSS-REFERENCE TO RELATED APPLICATIONS

This application is a continuation of International Patent Application No. PCT/US2023/073052, filed Aug. 29, 2023, entitled “Systems and Methods for Sequestering Carbon Dioxide and Neutralizing Acidification of Natural Water Bodies,” which claims priority to and the benefit of U.S. Provisional Application No. 63/401,959, filed Aug. 29, 2022, entitled “Ocean Based Carbon Removal Systems and Methods of Using the Same,” the entire disclosure of which is incorporated herein by reference.

### BACKGROUND

The present disclosure relates generally to systems and methods for reducing atmospheric carbon dioxide and mitigating impacts resulting therefrom, and more specifically, to systems and methods for transferring carbon dioxide from the fast carbon cycle to the slow carbon cycle of natural water bodies and neutralizing acidification of such water bodies.

Human activity has increased atmospheric carbon dioxide (CO₂) by approximately 50% (from about 280 to about 420 ppm) over the past 200-300 years due to the combustion of fossil fuels, land use changes, and other industrial processes. These anthropogenic increases in atmospheric CO₂ are causing a variety of environmental and societal problems, including global warming, increased wildfires, increased droughts, increased severity and frequency of storms, sea level rise, melting glaciers, and ocean acidification.

The global carbon cycle operates through a variety of response and feedback mechanisms between the Earth's primary carbon reservoirs, namely the marine and terrestrial biospheres, the atmosphere, the ocean, and sediments/rocks. The Earth's carbon cycle can be broken down into two distinct, but overlapping, components: the fast carbon cycle and the slow carbon cycle. The fast carbon cycle encompasses the movement of carbon via photosynthesis and respiration, as well as the continuous exchange of CO₂ amongst the biosphere, atmosphere, and ocean. The fast carbon cycle is dynamic and volatile, and it can be best understood as the flow of carbon through living ecosystems. In contrast, the slow carbon consists of the movement of carbon via gravity, pressure, chemical weathering, ocean currents, etc. These processes move carbon from living organisms and ecosystems into geological and deep-water reservoirs such as sediments, mineral deposits (e.g., oil, gas, coal), and deep waters. Slow carbon cycle reservoirs evolve very slowly.

Without human interference, carbon moves from the slow to the fast cycle over millions of years through volcanic activity, driven by the subduction and melting of limestones and oil and gas-bearing rocks, and over intermediate timescales through ocean upwelling. Prior to the relatively rapid increase in human population, carbon cycling between the atmosphere, ocean, biosphere, and geologic reservoirs, in both the fast and slow carbon cycles, was generally balanced in a manner that promoted stable climates, ocean chemistry, and ecosystems. Based on activities such as extracting and burning carbon rich resources and/or the like, humans are effectively moving 30+ billion tons of carbon from the slow to the fast cycle every year.

As a result, one of the greatest challenges facing humanity in the 21^{st} century is to develop scalable methods for removing CO₂ from the atmosphere and upper layers of natural water bodies (e.g., CO₂ in the fast carbon cycle) and durably sequestering it in, for example, deep waters (e.g., deep ocean), marine sediments, geological deposits, and/or the like (e.g., in or by the slow carbon cycle). Such efforts to stabilize and reduce atmospheric CO₂ and neutralize acidification of natural water bodies, in turn, limit the environmental and humanitarian damage that is associated with increasing atmospheric CO₂.

As such, a need exists for improved systems and methods for moving carbon from the fast carbon cycle to the slow carbon cycle and for neutralizing acidification of water bodies so as to reduce the partial pressure of CO₂ in the atmosphere, increase seawater pH, and beneficially impact the planet.

### SUMMARY

Embodiments described herein relate to methods and systems for sequestering carbon and transferring the carbon from the fast carbon cycle to the slow carbon cycle in a fast and efficient manner, and neutralizing acidification of natural water bodies. In particular, methods and systems described herein relate to the use of payloads, such as floating substrates formed from naturally occurring materials and/or alkaline materials (e.g., alkaline minerals and/or liquids) for carbon sequestration, and/or reducing acidification of natural water bodies to further facilitate carbon sequestration in a net carbon-neutral or carbon-negative process. For example, in some instances, such payloads can be deployed at predetermined locations in bodies of water and allowed to be transported (e.g., passively) under natural water currents where the payloads can sink to deep water and/or otherwise degrade, dissolve, disperse, and/or transition to transfer the sequestered carbon to the slow carbon cycle. The payloads described herein may be used as an independent component for carbon sequestration purposes (or other independent purposes), may be used in connection with the cultivation of a marine target product used for carbon sequestration purposes, and/or a combination thereof, or any other suitable purpose. In some implementations, the payloads or portions thereof can allow for selective control and/or enhancement of the payload's buoyancy, the release of nutrients, the promotion of the attachment and/or growth of target product(s) (or otherwise the accumulation of biomass), the sequestration of atmospheric and/or oceanic carbon, the albedo of surface seawater increasing reflection of solar radiation and reducing warming of the body of water, the mitigation of the effects of carbon dioxide induced acidification (e.g., of oceans and/or other water bodies) by increasing alkalinity of the body of water, and/or the like.

In some implementations, a method includes deploying a payload at a first location in a body of water while the payload is in a first configuration. The payload is allowed to travel via natural water currents to a second location in the body of water and to transition from the first configuration to a second configuration during travel from the first location to the second location to facilitate atmospheric carbon sequestration. The method includes quantifying an amount of the atmospheric carbon sequestration associated with the payload transitioning from the first configuration to the second configuration. In some implementations, the payload may be a substrate that may be seeded with a target product. In some implementations, such a substrate may be formed of naturally occurring material, which may include alkaline materials (e.g., alkaline mineral(s) and/or alkaline liquid(s)). In some implementations, the payload may be configured to enhance the alkalinity of at least a portion of the body of water, thereby promoting the sequestration of atmospheric carbon dioxide and/or neutralization of acidification in the body of water.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flowchart of a method for sequestering carbon via the fast carbon cycle using a naturally occurring substrate(s) and transferring the sequestered carbon to the slow carbon cycle, according to an embodiment.

FIG. 2 is a schematic block diagram of a system for forming substrates using naturally occurring materials, sequestering carbon via the fast carbon cycle and passively transporting the substrates from a first location to a second location in a body of water to transfer the sequestered carbon to the slow carbon cycle, according to an embodiment.

FIGS. 3A and 3B are schematic illustrations of a cultivation apparatus in a first configuration and a second configuration, respectively, according to an embodiment.

FIG. 4 is a schematic illustration of a cultivation apparatus including a coating formed from a alkaline material, according to an embodiment.

FIG. 5 is a schematic illustration of a cultivation apparatus including a first coating on a first side and a second coating on a second side of a substrate of the apparatus, according to an embodiment.

FIG. 6 is a schematic illustration of a cultivation apparatus formed from alkaline material, according to an embodiment.

FIG. 7 is a schematic illustration of a cultivation apparatus, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments and methods described herein relate to reducing the accumulation of atmospheric greenhouse gases (e.g., carbon dioxide) and/or enhancing the ability of natural systems to capture and sequester such atmospheric greenhouse gases. For example, carbon dioxide removal (“CDR”), as described herein, is any activity that moves carbon from the rapidly cycling reservoir of carbon dioxide in the atmosphere, upper ocean, and biosphere (e.g., the fast carbon cycle) into storage within a slow carbon cycle reservoir. Carbon removal is additive, durable, and quantifiable through direct and/or indirect measurements of mass transfers. When combined with rebuilding and conserving ecosystems that promote fast cycle carbon sinks, restorative carbon removal can both enhance the productivity of the fast carbon cycle while also moving carbon from the fast to slow carbon cycle. To be atmospherically significant, however, it is generally desirable for carbon sequestration technologies to be capable of transferring carbon at a multi-gigaton scale.

Water bodies such as oceans present a potentially powerful mechanism for nature-based CDR. For example, the surface ocean is continually exchanging carbon dioxide with the atmosphere, annually fluxing about 100 Gigaton (“Gt”) of CO₂ across the air-water interface. In the photic zone (i.e., the region of a body of water that receives enough sunlight to allow for photosynthesis), it also fixes about 40 Gt CO₂ in net primary production. Most of this carbon remains in the fast carbon cycle, but the ability of the ocean to capture and concentrate carbon dioxide from the air, albeit temporarily, may provide a lever for nature-based (e.g., water-based) CDR. Moreover, the deep ocean is a substantial carbon sink-durably holding about 37,000 Gt CO₂ (in dissolved form) away from atmospheric mixing for hundreds to thousands of years. However, the natural mechanism of carbon transfer from surface-ocean atmospheric flux to deep sea storage is relatively limited, resulting in about 10 Gt CO₂ annual sequestration. Thus, “water CDR” or “water-based CDR” (e.g., “ocean CDR” or “ocean-based CDR”), as described herein, represents a set of systems, methods, and/or engineering interventions to amplify this transfer of carbon from fast carbon cycle (e.g., at the surface of the water body, such as an ocean) to the slow carbon cycle (e.g., in or at deep waters such as deep ocean).

Embodiments and methods described herein, in general, include the deployment of payloads that are configured to perturb the chemistry and/or chemical properties of the surface ocean (or a surface layer of any other body of water), such that those perturbations result in dissolution of atmospheric carbon into the ocean and/or amplification of ocean transfer of carbon from fast carbon cycles to slow carbon cycles. For example, a payload may be configured to increase the yield of photosynthetic biomass in the surface ocean, which in turn, produces a chemical perturbation through the uptake and removal of dissolved inorganic carbon (DIC) from the water. Another such example is deploying a payload that results in the direct addition of dissolved or dissolving alkaline material to the water, increasing its pH. Both such perturbations, when applied to targeted areas of the surface ocean, may result in carbon sequestration of commercial quality.

Examples of ocean-based CDR can include, but are not limited to, the cultivation, accumulation, and sequestration of marine and/or terrestrial biomass; chemical weathering of alkaline minerals and/or fluids; the release of alkaline minerals and/or fluids into a water body (including oceans, seas, rivers, lakes, etc.) to enhance the alkalinity of the water; and/or the like. More specifically, marine species such as macroalgae, microalgae, grasses, plants, mangrove trees, biofilms, fungi, crustaceans, planktons, filter feeders, and/or the like (also referred to as “target products,” “marine biomass” or “marine mass”) have shown promise as a carbon sequestration technology as wild growth currently contributes to naturally occurring carbon sequestration to the seafloor. In some implementations, increasing and/or improving cultivation and accumulation of marine biomass can provide additional benefits. In addition, the cultivation of marine species can have many advantages compared to the cultivation of plants on land. For example, the cultivation of marine biomass typically leads to higher productivity and does not require significant use of scarce resources such as farmlands, freshwater, and/or additional nutrients. Cultivation of such target products has the potential to improve the quantity and/or rate of sequestration significantly due to increased cultivation productivity, increased preservation of organic carbon, and/or increased residence time of organic and inorganic carbon sinks relative to that resulting from naturally occurring species.

In some implementations, a CDR payload can be a substrate or structure that is seeded with a target product prior to deployment or to which target product in the wild can attach after deployment. The substrate(s) are deployed in a body of water such as open ocean and are configured to allow biomass to accumulate until reaching a certain threshold value. After accumulating a desired or threshold amount of biomass, the target product is allowed (or caused) to sink to the ocean floor, thereby effectively sequestering an amount of carbon dioxide captured by the target product. The sinking can occur with or without the substrate (either in part or as a whole). Various embodiments and/or methods associated with the cultivation and sequestration of such target products and/or the substrates or other structures supporting or at least partially floating such target products can include but are not limited to, for example, any of those described in U.S. Pat. No. 11,382,315 (the “'315 patent”), filed Jun. 8, 2021, and entitled “Systems and Methods for Cultivation for Target Product,” the entire disclosure of which is incorporated herein by reference.

In addition to sequestering carbon captured by the target products, it may be desirable to source, form, and/or produce the substrate on which the target product is seeded or otherwise coupled from naturally occurring materials (or from byproducts resulting from other processes) to limit carbon emissions associated with production. In addition or as an alternative, in some implementations, the naturally occurring material can sequester CO₂ directly in the production of the substrate, the transformation and/or transitioning of the substrate, the dissolution of the substrate (for example, via ocean alkalinization), and/or in the transport, deposition, and/or burial of the substrate if/when the substrate is removed from the surface of the body of water, the atmosphere, and/or a portion of the fast carbon cycle in the coupled surface water-atmosphere system. In some implementations, it may be desirable to allow such natural substrates to sink along with the target product, thereby reducing carbon emissions otherwise associated with the process of recovering used substrates. In some instances, floatation characteristics and/or the like of the natural substrates used for cultivation of marine target products can be controlled, thereby allowing the substrates to be deployed in a first location and, for example, passively transported to a second location, as described in further detail herein. Various embodiments and/or methods associated with using such passive substrates and/or substrates formed from naturally occurring materials can include, for example, any of those described in International Patent Application No. PCT/US2023/064917 (the “′917 PCT”), filed Mar. 24, 2023, and entitled “Floating Substrates for Offshore Cultivation of Target Products and Methods of Making and Using the Same,” the entire disclosure of which is incorporated herein by reference.

In some implementations, carbonaceous and/or alkaline materials (e.g., minerals and/or liquids), both naturally occurring and industrially produced, can be used to facilitate and/or enhance carbon sequestration and/or otherwise to neutralize acidification of natural water bodies. For example, some embodiments and/or methods described herein can include forming and/or coating at least a portion of a substrate from and/or with a carbonaceous and/or alkaline material, and/or that include a naturally occurring material such as an alkaline mineral and/or liquid for sequestering carbon in the deep ocean (or other water body) and/or enhancing alkalinity of the ocean or other water body, thereby improving its ability to sequester carbon. In some implementations, the substrates and/or coatings around at least a portion of the substrate can be configured to degrade and/or dissolve when the substrate is deployed in a body of water, which in turn can independently capture and/or sequester carbon, enhance water alkalinity, and improve its ability to sequester carbon or otherwise neutralize acidification, and/or transition the substrate from first configuration having a positive buoyancy to a second configuration having a negative buoyancy. In some implementations, the transitioning of the substrate to the second configuration causes the substrate to sink as an independent mode of carbon sequestration, or in addition to carbon sequestration associated with sinking an amount of target product that accumulated while the substrate was in the first configuration, or that otherwise comprised the first configuration. Various embodiments and/or methods associated with using substrates coated in a carbonaceous or alkaline mineral or material can include, for example, any of those described in International Patent Application No. PCT/US2023/064919 (the “′919 PCT”), filed Mar. 24, 2023, entitled “Floating Substrates Including Carbonaceous Coatings for Offshore Cultivation of Target Products and Methods of Making and Using the Same,” the entire disclosure of which is incorporated herein by reference.

In some implementations, payloads can include and/or can be formed at least in part by alkaline liquids and/or the like. For example, the substrates described herein may include or may be formed from and/or using alkaline liquids. For context, some conventional methods of CO₂ sequestration using alkaline fluids (liquid or gas) include direct injection of alkaline fluids into naturally occurring alkaline bedrock. Such conventional methods, however, can create environmental, geological, and/or public health hazards, and/or can use significant amounts of energy in the industrial weathering process, making such methods impractical for large-scale carbon sequestration.

In some implementations of the present disclosure, low-energy methods may be employed for using globally abundant, naturally occurring and/or industrially produced alkaline fluids, such as those found as surface and subterranean fluids, hydrothermal brines, basinal brines, oil-field brines, sub-seafloor fluids, evaporite brines, wastewater brines, desalination brines, among other alkaline fluids, that occur within alkaline mineral deposits, such as metal silicates (e.g., mafic/ultramafic igneous rocks), limestones, dolostones, and evaporite deposits, to sequester CO₂ from the Earth's fast carbon cycle (the upper ocean and atmosphere) to its slow carbon cycle (deep ocean, marine sediments, rocks and other upper subterranean reservoirs). Such alkaline fluids may be naturally high in pH, alkalinity, and divalent cation concentration, and therefore ideally suited for large scale CO₂ sequestration via ocean alkalinity enhancement, enhanced weathering, river liming and/or otherwise neutralizing acidification of natural water bodies.

Such natural alkaline fluids can also have high temperatures at the point of extraction, which can be advantageous if used in the production of substrates that are aggregated, for example, with cementitious and/or polysaccharide hydrogels by reducing the heat input required to activate and cure these binders. The characteristically high concentration of divalent cations and alkalinity of such alkaline fluids can also speed the activation and curing process of cementitious and/or hydrogel binders used in the production of substrates engineered for CO₂ sequestration. Various embodiments and/or methods associated with using alkaline fluids independently and/or in one or more processes for forming substrates can include, for example, any of those described in International Patent Application No. PCT/US2023/071339 (the “339 PCT”), filed Jul. 31, 2023, entitled “Systems and Methods for Sequestering Carbon Dioxide Using Alkaline Fluids,” and/or U.S. Provisional Application No. 63/525,326 (the “′326 provisional”), filed Jul. 6, 2023, entitled “Systems and Methods for Producing, Loading, Storing, Transporting, and Deploying Alkaline Materials Via Vessels for Sequestering Carbon Dioxide and Mitigating Acidification of Natural Waters,” the entire disclosures of which are incorporated herein by reference.

In some embodiments, a CDR payload can include alkaline fluids that can be used to neutralize acids or acidic materials released into the water bodies through one or more additional or other processes associated with the CDR payload. For example, the cultivation and sinking of biomass (e.g., macroalgae and/or any other biomass) can, in some cases, release small quantities of organic acids into the water bodies and/or the atmosphere through, for example, microbial remineralization of particulate organic carbon, organic acid leaching, and/or production of dissolved organic carbon. In some implementations, the alkaline fluids included in the CDR payload can be used to capture and/or durably retain in solution the CO₂ that is released through the one or more additional or other processes associated with the CDR payload, while neutralizing release of acidity.

Moreover, any of the payloads described herein (e.g., substrates formed using naturally occurring cellulosic materials, carbonaceous or other alkaline materials, and/or alkaline fluids, with or without target product seeded thereto or otherwise supported thereby) may be deployed at strategic locations in a body of water such that they sequester atmospheric carbon and/or increase alkalinity of the body of water while being transported passively to the deep ocean. The payloads may continue to sequester carbon in the deep ocean and/or reduce acidity of the ocean, and may eventually sink to the ocean floor to transfer the sequestered carbon to the slow carbon cycle. The entire lifecycle of any of the payloads described from extraction (e.g., from natural mineral sources or any other source(s)), manufacturing, assembly, transportation, and/or deployment in the body of water, to the sequestering of carbon and transfer of carbon to the slow cycle occurs in a net negative carbon footprint, thus resulting in a decrease in the global carbon footprint.

Various embodiments and/or methods for sequestering carbon and transferring the carbon from the fast to the slow carbon cycle described herein may provide one or more benefits including, for example: (1) dissolving at known rates to control floating or sinking of a payload such as a substrate after a predetermined time; (2) releasing alkaline ions into the body of water, thus beneficially reducing acidity of the body of water in contrast to organic coating that release acid when dissolved, thus releasing carbon dioxide; (3) forming coatings on or around portions of a payload from naturally occurring materials, thus reducing introduction of synthetic materials into natural bodies of water (e.g., ocean, sea, rivers, lakes, ponds, etc.); (4) maintaining a surface having high free energy (e.g., high bonding potential) and high affinity for cation binding, thus promoting attachment of biological materials such as target products via mineral binding or cation binding; (5) deterring biological degradation that may remineralize organic material or portions of a substrate as carbon dioxide before sinking through the body of water and/or burial; (6) chemically buffering carbon dioxide released through biological decomposition (e.g., microbial decomposition, heterotrophic decomposition, etc.) as bicarbonate and/or carbonate ions; (7) having sufficient density (e.g., greater than 1 g/cc or seawater density) to accelerate sinking of the payload, for example, when rapid sinking is desired; (8) enabling entrapment of nutrients within a crystalline matrix and beneficially providing controlled release of the nutrients of other supplementary materials that support biomass growth and/or accumulation, for example, via dissolution of coatings and/or the like; (9) increasing albedo of a surface of the body of water (e.g., seawater), thus promoting reflection of solar radiation and mitigating impact of carbon dioxide induced warming of the body of water via greenhouse effect; (10) mitigating impact of carbon-dioxide-induced acidification on marine calcifiers by releasing Ca²⁺ and CO₃²⁻ ions into the body of water; (11) promoting atmospheric carbon sequestration by directly capturing carbon dioxide from the atmosphere via dry (e.g., land based) mineralization; (12) using commercially available materials for forming coatings, substrates, and/or other payloads, thus decreasing manufacturing complexity, supply chain issues, and cost; and/or the like.

Moreover, the embodiments and/or methods described herein allow for deployment of the substrates at a first location in the body of water (e.g., an ocean) and passive transport to a second location (e.g., the deep ocean), which advantageously reduces costs and carbon footprint of the deployment process. For example, the cost of distributing a payload broadly over a geographically large and remote region of the ocean is high. For example, in general, recoverable vessels are engineered to withstand open ocean conditions and need to carry sufficient fuel for a return voyage, manned vessels carry food and safety materials and incur the risk of injury or death, and drones intended for one-way transport to these regions are costly and may fail prior to arrive at a desired deployment location. In some implementations, any of the embodiments and/or methods described herein may avoid such costs and risks by relying, at least in part, on natural current of the body of water. In some embodiments, payloads described herein can be produced, stored, transported, and/or deployed via vessels that are otherwise traveling across the body of water along known routes (e.g., shipping vessels). Examples of such vessels and/or methods of using such vessels to deploy CDR payloads can include but are not limited to those described in the ′326 provisional.

In addition to the benefits and/or advantages described above, in some implementations, carbon sequestered (directly or indirectly) via the embodiments and/or methods herein can be quantified, calculated, and/or valued, allowing for the sale of carbon offset credits and/or the like. For example, in an attempt to abate greenhouse gas emissions, governments and/or regulatory authorities have established greenhouse gas emissions caps and, where compliance is impracticable, have allowed organizations to comply with the emissions caps by purchasing carbon credits and/or offsets. Accordingly, carbon sequestered using water-based CDR, as described herein, can be quantified, calculated, and/or valued, and a credit tied to and/or otherwise associated with the calculated amount of carbon sequestered can be sold in a carbon credit market (or any other suitable market).

In some implementations, a method includes deploying a payload at a first location in a body of water while the payload is in a first configuration. The payload is carried by and/or allowed to travel via natural water currents to a second location in the body of water and transition from the first configuration to a second configuration during travel from the first location to the second location to facilitate atmospheric carbon sequestration. The method includes quantifying an amount of the atmospheric carbon sequestration associated with the payload transitioning from the first configuration to the second configuration. In some implementations, the payload may be a substrate that may be seeded with a target product. In some implementations, such a substrate may be formed of naturally occurring material, which may include an alkaline liquid.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

As used herein, the term “target product” generally refers to one or more aquatic and/or marine species of interest. For example, a “target product” can include but is not limited to aquatic and/or marine species such as crustaceans, plankton, archaea filter feeders (e.g., oysters, clams, etc.), marine bacteria, biofilms, fungi, heterokonts like algae(s) (e.g., microalgae, macroalgae, etc.), and/or the like. In other implementations, however, a target product can refer to any suitable species whose cultivation leads to a desired result (e.g., as a harvested product, for bioremediation, for carbon capture and sequestration, and/or the like). In some implementations, the target products described herein can be cultivated and/or used for the purpose of bioremediation, eventual cultivation/harvesting, and/or for sequestering carbon dioxide. The target products may generally include negatively, neutrally, and/or positively buoyant species (e.g., species that sink, remain suspended, or float in water as they grow). Such target products may propagate or reproduce by producing gametophytes and/or sporophytes that can rapidly grow in a body of water and sequester atmospheric carbon via photosynthesis.

The target products described herein can be select marine species whose natural and/or desired habitat is a body of water. When referring to a body of water, it should be understood that the body of water can be selected based on characteristics that result in a desired outcome (e.g., direct or indirect carbon capture/sequestration, facilitating the cultivation of target products that capture carbon dioxide via photosynthesis, and/or the like). Accordingly, though specific bodies of water may be referred to herein (e.g., an ocean or sea), it should be understood that the embodiment, example, and/or implementation so described is not limited to use in such an environment unless the context clearly states otherwise. Moreover, the terms “seawater” and/or “saltwater”) as used in this specification are intended to refer to any body of water the constituents of which include a certain concentration of salt(s). In contrast “freshwater” can refer to any body of water the constituents of which do not include or include limited concentrations of salt(s). Saltwater, for example, can refer to the water forming oceans, seas, bays, gulfs, etc. Freshwater, for example, can refer to the water forming rivers, lakes, meteoric waters, groundwaters, subsurface reservoirs, etc. Moreover, bodies of water described herein can also include certain mixtures of freshwater and seawater (generally known as “brackish”) such as, for example, the mixture of river water and seawater found in estuaries and/or the like. For example, while the term “ocean-based CDR” specifically refers to an ocean, any of the embodiments, techniques, processes, methods, etc. described herein as being used for ocean-based CDR can be employed in other bodies of water (e.g., bodies of saltwater, freshwater, and/or brackish water) or other fluids.

It should be noted that the term “example” as used herein to describe various embodiments is intended to indicate that such embodiments are possible examples, representations, and/or illustrations of possible embodiments (and such term is not intended to connote and/or convey that such embodiments are necessarily extraordinary or superlative examples). Similarly, it should be understood that when referring to certain examples and/or components or aspects thereof, it is not intended to imply or convey that such examples and/or components or aspects thereof are essential or necessary unless explicitly stated.

The terms “coupled,” and the like as used herein mean the joining of two members directly or indirectly to one another. Such joining may be stationary (e.g., permanent) or moveable (e.g., removable or releasable). Such joining may be achieved with the two members, or the two members and any additional intermediate members, being integrally formed as a single unitary body with one another or with the two members or the two members and any additional intermediate members being attached to one another.

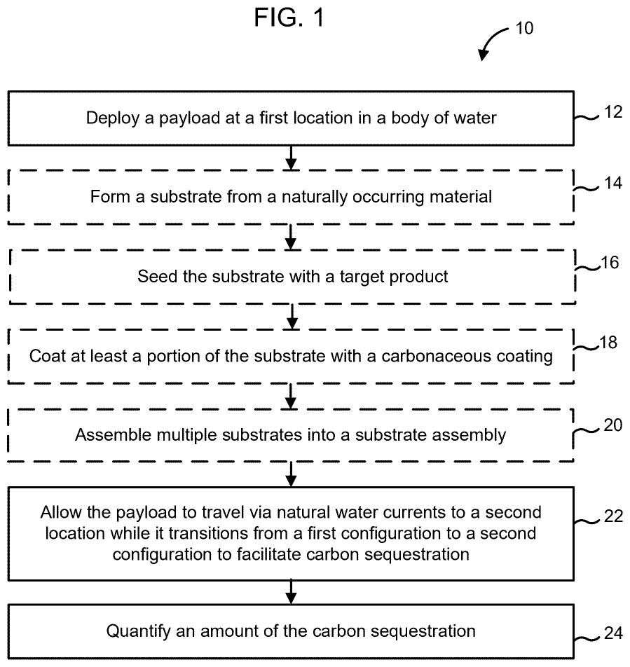

Referring now to the drawings, FIG. 1 is a flowchart of a method 10 for ocean-based carbon dioxide removal (CDR) for sequestering atmospheric carbon according to an embodiment. The method includes deploying a payload at a first location in a body of water, at 12. The payload can be any suitable device, material, mineral, fluid, structure, etc. configured for ocean-based CDR and/or otherwise associated with systems for ocean-based CDR. For example, payloads can include materials, structures, fluids, etc. configured to interact with a portion of the body of water in which they are deployed to facilitate ocean-based CDR. In some implementations, such interaction can result in and/or otherwise cause the payload to transition from a first configuration to a second configuration, which in turn, can contribute to and/or form one or more steps in a process of transferring carbon from the fast carbon cycle to the slow carbon cycle. In some implementations, such interaction can result in and/or otherwise cause the payload to modify one or more characteristics of the body of water in which it is deployed, which in turn, can enhance the water's natural ability to transfer carbon from the fast carbon cycle to the slow carbon cycle. In some implementations, such interaction can have and/or can result in any suitable predetermined and/or desired outcome, or any suitable combination(s) thereof, the result of which can enhance and/or facilitate ocean-based CDR.

In some implementations, the payload can be, for example, a substrate or the like that can be at least temporarily buoyant. For example, in some implementations, the method 10 optionally includes forming a substrate form a naturally occurring material, at 14. In some embodiments, the substrate may include a solid structure having any suitable shape, for example, square, rectangular, ovoid, polygonal, asymmetric, irregular, and/or the any other shape. In some embodiments, the substrate may be a solid block. For example, strands, fibers, sheets, mats, and/or chunks of constituent material can be compressed into a solid block to form the substrate (e.g., via a mechanical or hydraulic press, a mold, and/or any other suitable process). In some embodiments, the compression can be such that a desired space exists between the strands, fibers, sheets, mats, and/or chunks to result in a substrate having a desired porosity, and/or the like. In some embodiments, the substrate may be hollow or may be formed into a hollow block. For example, the substrate may define one or more internal volumes, cavities, receptacles, and/or voids (e.g., to trap or hold air, thereby increasing a buoyancy of the substrate), or may be formed in the shape of a cage or a net. The substrate may be positively buoyant, allowing the substrate to float on a body of water, for example, an ocean, a sea, a river, a lake, a pond, etc., at least for a certain period of time or under certain environmental conditions. In some embodiments, the substrate may be or may become neutrally buoyant or negatively buoyant, as described herein.

In some embodiments, the naturally occurring material may generally include an organic material that is readily available in natural environments, or is produced naturally as the main product or byproduct of farming or other cultivating/harvesting operations. For example, the naturally occurring material may include an agricultural waste or residue product or a forest waste or residue product. In various embodiments, the naturally occurring material may include, but is not limited to, terrestrial biomass (e.g., woody biomass) such as, for example, to grasses (e.g., switch grass, wild grass, genetically modified grass, etc.), wood chips (e.g., obtained from downed trees or wood reclamation operations), wood excelsior fibers, straw fibers, hog fuel, corn cobs, coconut shells, coconut fibers, hemp, jute, compost, xanthan gum, agar, alginate, cardboard or nanocellulose fibers, paper, etc. In various embodiments, the naturally occurring material may include aquatic (e.g., marine) biomass. In various embodiments, the naturally occurring material may include any suitable combination(s) of terrestrial biomass, any suitable combination(s) of aquatic biomass, or any suitable combination(s) of terrestrial and aquatic biomass.

In some embodiments, the naturally occurring material may be a biobased material, or biodegradable polymer (e.g., polyhydroxyalkanoate based aliphatic polyesters such as PHA or PHB) produced from natural materials such as sugar, oils, molasses, coconut oil, palm oil, chitin, mycelium, etc. The naturally occurring materials (e.g., the biomass, biobased material, biodegradable polymers, etc.) may be formulated to naturally biodegrade in water (e.g., freshwater, saltwater, brackish water, etc.), for example, via hydrolysis and/or enzymatic digestion and/or otherwise formulated to lose buoyancy over time.

The organic or naturally occurring materials may be formed into the substrate using any suitable process. In some embodiments, the substrate may be formed by placing and/or forming the naturally occurring materials into one or more tubes, tube-like structures, meshes, socks, bags (e.g., a bag, a pouch, a bailer, or any other container defining an internal volume), over braids, spiral wraps, wattles, slit socks, ropes (e.g., similar to those used to prevent land erosion, or flood barriers), and/or the like. In some embodiments, the substrate can be formed with any number of layers (with or without one or more base layers) formed from naturally occurring biobased material such as, for example, coconut fibers, wood excelsior fibers, straw fibers, natural twine, compost, biobased biodegradable plastic perforated fabric, mesh formed into a tubular structure, and/or the like. In some embodiments, the organic naturally occurring material may be formed into the planar substrate by stitching, weaving, laminating, or otherwise compressing between the two or more sheets (e.g., scrim fabrics, perforated sheets, meshes, rovings, etc.) to form the substrate (e.g., flat sheets or mats).

In some embodiments, the naturally occurring material may be mixed with an adhesive or binder before being forming into a block, or an adhesive or binder may be poured over, or otherwise applied to the substrate after being formed into the block so as to cause the substrate to retain its shape. In such embodiments, the adhesive or binder may include a biocompatible, or otherwise biodegradable adhesive or binder, including, but not limited to beeswax, gelatin, molasses, tree sap, protein-based polymers, any suitable biodegradable polymer, or combination thereof. In some embodiments, the adhesive or binder may include or be spiked with nutrients, fertilizers, or other additives and/or supplementary materials to promote growth of the target product therein.

In some implementations, a substrate formed, made, or assembled into a solid structure from one or more naturally occurring materials may be seeded with one or more target products. For example, the method 10 may optionally include seeding the substrate with a target product, at 16. In some implementations, the substrate may be seeded with the target product before being deployed (e.g., pre-seeded). For example, the substrate may be seeded immediately before deployment in the body of water such that growth of the target product occurs substantially within the body of water. In other implementations, the seeded target product may be allowed to grow or germinate for a period of time before deployment into the body of water, with subsequent growth of the seeded target product occurring in the body of water. Allowing the seeded target product to grow for the period of time prior to deployment may advantageously allow the target product to become integrated within the substrate such that the seeded target product is inhibited from dissociating from the substrate when the substrate is deployed into the body of water. As such, all or a significant portion of the seeded target product may remain attached to or incorporated within the substrate after deployment.

The target product (e.g., gametophytes or sporophytes of marine algae, or any other target product described herein or biological component thereof) may be seeded directly or indirectly into the substrate and/or into a coating or layer of thereof. Seeding may be performed by disposing the target product in or on the material (e.g., the naturally occurring material used to form the substrate) before the substrate is formed, during formation of the substrate, after formation of the substrate, before or after coating the substrate with a coating, and/or at any other suitable time. In some implementations, seeding may be performed, for example, by immersing the substrate in a volume of liquid (e.g., seawater, saltwater, or culture medium) within which the target product is being grown or stored allowing a portion of the target product included in the volume of liquid to become trapped in the pores of the substrate and/or the coating, thereby forming the seeded substrate. The target product may be mechanically trapped within the substrate, for example, within pores that may be present in the substrate or coating/layer thereof.

In some embodiments, the substrate and/or layer/coatings thereof may include binders or other materials to facilitate adhesion of the target product to the substrate. For example, cationic binders, hydrogels, adhesives, polymers, or other seed binders may be included in the substrate to attract the target product (e.g., sporophytes or gametophytes) towards the substrate and keep the target product in proximity of the substrate until a strong adhesion or attachment is formed between the target product and the substrate. Other substances that may be used to enhance adhesion of the target product to the substrate may include, but are not limited to rheology modifiers, agglutinants, and other additives including glycerol, molasses, high molecular weight polysaccharides, and other polymeric materials such as polyethylene oxide.

In some embodiments, the substrate and/or layers/coatings thereof may include (e.g., be spiked or infused with) nutrients, fertilizers, or other additives and/or supplementary materials to promote growth of the target product therein. For example, one or more portions of the substrate may be sprayed with a fertilizer formulated to accelerate growth of the species of the target product. In some embodiments, the substrate may include additives formulated to suppress contamination of target product. For example, the substrate can include, be saturated with, or be impregnated with a growth substrate material such as, for example, an enriched seawater medium, pasteurized seawater, filtered seawater, seawater mixed with buffer solutions including but not limited to sodium nitrate (NaNO₃) solution, potassium dihydrogen phosphate (KH₂PO₄) solution, germanium dioxide (GeO₂), and/or the like. In some embodiments, the substrate may be infused with iron particles, or co-winded, coiled, and/or intertwined with an iron or an iron-containing thread, filament, or string to provide a source of iron (Fe) nutrient to the target product.

In some embodiments, one or more portions of the substrate may be inoculated with one or more diazotroph microorganisms including single-celled archaea organisms, bacteria such as cyanobacteria, azotobacter, rhizobia, Frankia, and/or the like (e.g., microbiota), capable of converting molecular nitrogen (N₂) from air into ammonia (NH₃) (e.g., fixing nitrogen). As previously described, the substrate may be porous, which in turn, may promote passive release of the fertilizer, additives, growth promoters, or other substance infused therewithin overtime, thus providing continuous dosing of such substances to the seeded target product, and/or retain such substances in close proximity of the target product. Various embodiments of target products and substrates including target products may include and/or may be similar to or substantially the same as any of the target products and/or substrates described in the '315 patent and/or the ‘917 PCT.

In some embodiments, the substrate may additionally, or alternately, include or may be formed, at least in part by, a naturally occurring alkaline salt, fluid, and/or the like. For example, alkaline minerals, compounds, salts, etc. can include but are not limited to limestone (calcium carbonate (CaCO₃)), dolomite or dolostone (calcium magnesium carbonate (CaMg(CO₃)₂)), magnesite (magnesium carbonate (MgCO₃)), lime (calcium oxide (CaO)), slaked or hydrated lime (calcium hydroxide (Ca(OH)₂)), brucite (magnesium hydroxide (Mg(OH)₂)), magnesium oxide (MgO), various forms of lye (KOH, NaOH), pumice (for buoyancy), alkaline mafic/ultramafic metal silicate minerals and/or rocks (to sequester CO₂ via ocean alkalinization and/or for buoyancy), naturally occurring carbonates and other salts, air or other compressed gas (for porosity, permeability, and/or buoyancy), any other suitable organic and/or inorganic product, waste product, and/or any combination(s) thereof.

In some embodiments, the alkaline coatings, such as various forms of lye (KOH, NaOH), may confer antimicrobial, antibacterial, and/or antifungal properties that could serve to sterilize the biomass or other materials forming or included in the buoy to prevent or limit a likelihood of the biomass or other such materials from introducing pests or other contaminants into the region where the biomass is transported, processed, and/or deployed, which in some cases, may satisfy import/export regulations of the importing and/or exporting country or other governing or regulatory body.

In some embodiments, the alkaline material may include carbonaceous and/or other alkaline material, such as a carbonate fraction (also referred to herein as “aggregate”), which can be used, for example, to facilitate dissolution of the substrate, provide carbon dioxide (CO₂) sequestration via alkalinization, and/or provide ballast for the substrate. In some embodiments, the carbonaceous material may include CaCO₃ (e.g., crushed limestone), CaMg(CO₃)₂ (e.g., crushed dolostone), and/or MgCO₃ (e.g., magnesite). In some embodiments, the naturally occurring material forming the substrate or at least layer(s)/coating(s) thereof may also include a silicate fraction, for example, pumice and/or other low density vesicular rock (e.g., mafic rock, ultramafic rock, and/or minerals) to enhance buoyancy of at least a portion of the substrate. In some embodiments, the naturally occurring or industrially produced material forming at least a portion of the substrate or layer(s)/coating(s) thereof may also be mixed with a surfactant foam to create an aerated final material.

In some embodiments, the alkaline naturally occurring material may include a metal oxide fraction such as, for example, iron oxide (Fe₂O₃) and/or other iron (Fe) or manganese (Mn) bearing oxide (e.g., to adjust buoyancy, for ballast, and/or to control orientation of substrate when included one side of the substrate). In some embodiments, the naturally occurring material may include one or more organic or inorganic binders, for example, to hold the material together and/or adhere it to the substrate. Suitable binders may include, but are not limited to carbonate binders (e.g., CaO, Ca(OH)₂, etc.), MgO, Mg(OH)₂, and/or other cementitious binder, or organic binders, for example, organic resin, polysaccharide gel, proteinaceous binder, adhesive, any other suitable organic binder, or combination thereof. In some embodiments, the naturally occurring material may include an accelerant to increase or decrease the rate of hydration and/or mineralization of the alkaline material.

In some embodiments, the method 10 may optionally include coating at least a portion of the substrate with a carbonaceous and/or other alkaline coating, at 18. For example, any of the alkaline and/or carbonaceous materials, minerals, salts, etc. described above can be used to form a portion of the substrate or can be used as a coating that is applied over a substrate, which may be formed from naturally occurring material(s), synthetic material(s), and/or combinations thereof. In some embodiments, the coating may include one or more additives and/or supplementary materials, for example, nutrients such as nitrogen (N), phosphorous (P), iron (Fe), and/or major/minor/trace elements in proportions supportive of photosynthesis and vegetative growth of the target marine product. In some embodiments, the coating may include a catalyst, for example, freshwater, seawater, subsurface, or surface brine. In some embodiments, the catalyst may not be included in the coating, and instead may be provided by the body of water (e.g., seawater).

In some embodiments, the elemental ratios of the coatings may be configured and/or selected to be compatible with those of the environment (e.g., at or around a deployment location, target location, etc.) to avoid disturbing potentially delicate elemental ratios that exist in that environment when they are released. For example, a coating may include and/or may be formulated with MgCO₃ and CaCO₃, or Mg(OH)₂ and Ca(OH)₂ at molar ratios of 5:1 in order to substantially match the molar ratio of Mg:Ca in seawater, which is known to control the polymorph and Mg-content of CaCO₃ that is precipitated both biotically and abiotically (e.g., seawater molar ratio of Mg:Ca<2 may favor precipitation of low-Mg calcite polymorphs of CaCO₃, while seawater molar ratio of Mg:Ca >2 may favor precipitation of aragonite and high-Mg calcite polymorphs of CaCO₃).

The coating may be applied on the substrate using any suitable method. For example, the aggregate, binder, and additives may be mixed with water, seawater, and/or brine, and used to coat floating and/or sinking substrates deployed in ocean and natural water bodies. In some embodiments, the coating may be disposed on the substrate by disposing the substrate in cages that are suspended from a circulating cable (e.g., a ski chair lift cable), and are passed through or dipped in vessels containing a mixture of the coating material (e.g., a slurry, suspension, etc.). In some embodiments, the cages may include polytetrafluoroethylene (PTFE) (e.g., TEFLON™ or TEFLON™ coated) cages that may move at a rate of about 40 cages/hour to about 60 cages/hour, inclusive, through the vessels, for example, to provide a production target in a range of about 200 ton/hour to about 600 ton/hour, inclusive. In some embodiments, the cages may be transported through a furnace (e.g., furnace tunnels) between coating applications to cure the coating. In some embodiments, the substrate may be disposed on a conveyor system (e.g., a walled conveyor system) and moved through vessels of the coating, or the coating may be sprayed or otherwise, deposited on the substrate as the conveyor moves. In some embodiments, the conveyor may also move through furnaces to cure the coating, as described herein. In some embodiments, the conveyor may have a width of about 6 meters and a depth of about 0.5 meters, inclusive, and may be configured to move at a rate of about 10 cm/second to about 20 cm/second, inclusive, for example, to provide a throughput of 200 ton/hour to about 600 ton/hour, inclusive. Accordingly, any of the substrates described herein can be formed from, can include, and/or can be coated with alkaline salts or carbonaceous materials including any of the materials and/or coatings described in the ‘919 PCT.

While the coated or uncoated substrates are described above as being seeded (e.g., actively, directly, indirectly, or otherwise pre-seeded prior to or during deployment), in other implementation, the coated or uncoated substrates can be deployed into a body of water without being seeded. In such implementations, the coated substrate may be configured to attract and retain target products (or biological components thereof) naturally present in the body of water. Moreover, in some such implementations, the coated substrates can be configured to include and/or release any of the substances, binders, nutrients, fertilizers, additives, growth promoters, etc., which in turn, can attract and/or retain target product (or biological components thereof) naturally present in the body of water in which the substrate is deployed, thereby allowing natural or passive seeding of the substrate. In some implementations, a coated substrate can be pre-seeded and can be configured to attract and/or retain target products (or biological components thereof) naturally present in the body of water in which the substrate is deployed.

In some embodiments, the payload may be and/or may include an alkaline fluid. Such alkaline fluids may react with carbon dissolved in water (e.g., ocean water) and/or atmospheric CO₂ to sequester carbon. In some implementations, the payload may be a container or reservoir at least temporarily storing the alkaline fluid and configured to selectively release the alkaline fluid over time. In some implementations, the payload may be alkaline fluid that is frozen into a solid form. In some implementations, the payload may be a substrate or coating that is formed at least in part using alkaline fluids.

Any of the alkaline fluids that are used as the payload, substrate, coating, binder, etc. described herein may be derived from natural or industrial reaction of water with alkaline minerals (e.g., metal silicates, carbonates, evaporites), which are globally abundant and form 45% of the Earth's continental crust (which covers 30% of Earth's surface) and nearly 100% of subsurface (i.e., below the upper sedimentary layer) oceanic crust (which covers 70% of Earth's surface).

In some embodiments, the alkaline fluids may include metal silicate solutions. Metal silicates include igneous rocks, including those classified as felsic (e.g., granite, rhyolite, etc.), intermediate (e.g., diorite, andesite, etc.), mafic (e.g., gabbro, basalt, etc.), and ultramafic (e.g., peridotite, komatiite, etc.) rocks. Metal silicates generally react with water and seawater to generate alkalinity and divalent cations (e.g., Ca²⁺, Mg²⁺, Fe²⁺, etc.), which can sequester CO₂ in the form of aqueous bicarbonate ion (HCO₃⁻) and carbonate ion (CO₃²⁻) and solid carbonate minerals (CaCO₃, MgCO₃, CaMgCO₃, FeCO₃, etc.). For example, one mineral involved in the production of the alkaline waters involved in the reaction with metal silicates is olivine, which is a magnesium-iron silicate with the chemical formula (Mg²⁺, Fe²⁺)₂SiO₄. The olivine content, and thus CO₂ sequestration potential of metal silicates and the igneous rocks that they comprise increases towards the ultramafic end of the igneous classification spectrum (i.e., with olivine content and CO₂ sequestration potential increasing in the following order: felsic, intermediate, mafic, ultramafic).

In some embodiments, the alkaline fluids may include silicate based alkaline solutions, carbonate based alkaline solutions, or evaporite based alkaline solutions. Some examples of idealized metal-silicate carbonation reactions that yield silicate-based alkaline solutions or fluids (e.g., waters) suitable for CO₂ sequestration and/or neutralization of acidification of water bodies may include, but are not limited to:

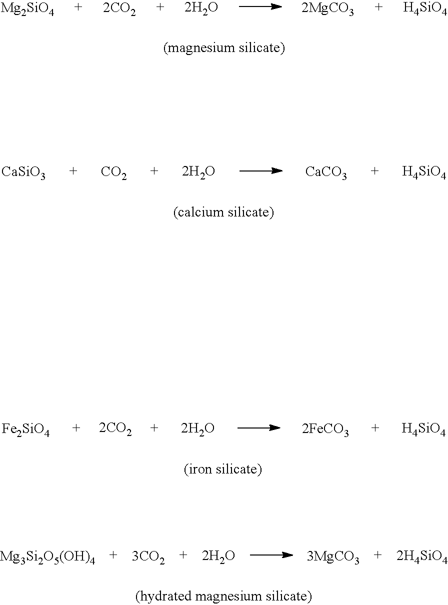

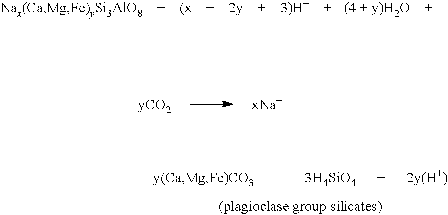

Some examples of carbonate mineral dissolution reactions that yield alkaline fluid (e.g., waters) suitable for CO₂ sequestration are:

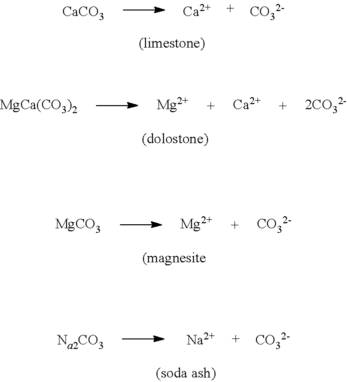

The liberated CO₃²⁻ ions from these carbonate dissolution reactions take up free H+ (protons) via the reaction:

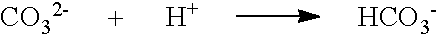

Some examples of metal oxide mineral dissolution reactions that yield alkaline fluid (e.g., waters) suitable for CO₂ sequestration are:

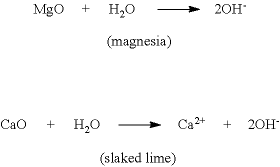

Some examples of metal hydroxide mineral dissolution reaction that yields alkaline fluid (e.g., waters) suitable for CO₂ sequestration are:

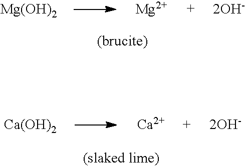 [SMILES: "Mg(OH)2" ; [Mg+2] ; "2OH-" ; "Ca(OH)2" ; [Ca+2] ; "2OH-"]

Some examples of lye mineral dissolution reaction that yields alkaline fluid (e.g., waters) suitable for CO₂ sequestration are:

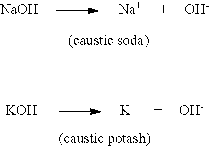

The liberated OH-ions from this reaction will take up free H+ (protons) via the reaction:

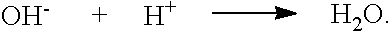

Thus, these dissolution reactions decrease free H+ (acting to increase pH and reverse acidification) and increase alkalinity of the surface waters (e.g., ocean alkalinization or alkalinity enhancement), thereby shifting the carbonate equilibria below to the right, resulting in a net transfer of atmospheric CO₂ to aqueous CO₂ via Henry's Law to re-establish the carbonate equilibria:

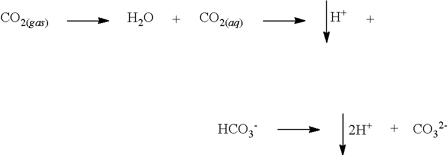

The aqueous HCO₃⁻ and CO₃²⁻ ions can be stable in natural aqueous systems such as lakes, ponds, rivers, seas, or oceans, and can remain stable for hundreds to thousands of years.

In some embodiments, the alkaline fluids included in the substrates described herein may be obtained from, sourced from, or extracted from natural sources or natural systems, such as, for example, surface waters, shallow subsurface waters, hydrothermal brines, deep subsurface waters, oil field brines, sub-seafloor brines, and evaporite brines. Surface waters include any alkaline waters found on the surface of land or the oceans, including alkaline lakes, rivers, cold springs, hot springs, and alkaline freshwater lenses floating on the surface of the ocean due to their relatively low density. Shallow subsurface waters include groundwaters found in the upper portion of the continental crust. Hydrothermal brines include brines formed through reaction of water, seawater, or brine with hot alkaline rocks and/or magma. Deep subsurface waters include basinal brines, which are brines trapped in ancient basins (geosynclines) that are now landlocked, and potentially deeply buried under sediments and rocks. Oil field brines include brines co-occurring with oil and gas deposits that are in some cases extracted and isolated through drilling for, and extraction of oil and gas from the subsurface. Sub-seafloor brines include brines derived from the reaction of seawater that has infiltrated the oceanic crust, reacting with alkaline basalt in the upper layers of the oceanic crust and with highly alkaline ultramafic deposits in the deeper layers of the oceanic crust. Evaporite brines include brines produced from the partial evaporation and resulting ionic concentration of meteoric water, seawater, or other natural waters in landlocked or marginal marine basins.

It should be appreciated that the aforementioned references for obtaining or sourcing alkaline fluids are only for illustrative purposes and alkaline fluids obtained from other natural sources may be used as at least a portion of a payload for ocean-based CDR and/or in forming the substrates and/or coatings described herein. All such implementations are contemplated and should be understood to be within the scope of the present disclosure.

Examples of alkaline minerals deposits that host alkaline groundwaters and brines include metal silicates (e.g., mafic/ultramafic igneous rocks), carbonates (e.g., limestones, dolostones, magnesite) and evaporite deposits (e.g., brucite). Alkaline solutions can also be extracted from these various natural systems through conventional well-drilling, recirculation, and/or surface collection methods.

In some embodiments, forming the substrate as described above at 14, can include forming the substrate using the alkaline fluids in liquid form as at least a portion of the substrate. In some embodiments, the alkaline fluids may be included in, incorporated in, or formed into a solid substrate. For example, the alkaline fluids can be disposed within substrates that include floatable solid substrates (coated or uncoated) such as those described above and/or in, for example, the '315 patent, the ‘917 PCT, and/or the ‘919 PCT.

In some embodiments, the alkaline fluids may be used in the construction of the floatable solid substrates themselves. For example, the alkaline fluids may be incorporated, absorbed, and/or imbued in the materials used to form the substrates (e.g., buoys). In such embodiments, the gradual degradation or dissolution of the buoys in oceans or other water bodies could release the alkalinity associated with the alkaline fluids, even if those alkaline fluids had been precipitated out as alkaline minerals through the process of constructing the buoy. In some embodiments, the substrate may be formed by binding and/or constructed from a partially cementitious material (e.g., similar to construction of marine buoys), and alkaline fluids may be used in the activation of the cementitious reactions that bind the buoy together. Thus, the alkaline fluid may be incorporated in the cementitious binder such that the binder serves as a reservoir of the alkaline salt that was included in the alkaline fluid. The alkalinity stored in the cementitious binder may then be released as such substrates dissolve, effectively transporting the alkalinity from the natural alkaline waters to the ocean or other aqueous environment for the purpose of CO₂ sequestration via alkalinization.

In some embodiments, forming solid substrates includes using the alkaline fluids as a hydration source of a polysaccharide binder used in the construction of the substrate from an organic naturally occurring material (e.g., psyllium or rice husk), that may result in a hydrogel and/or mineralized hydrogel. Under such conditions, the formation of the hydrogel may essentially stabilize and immobilize the alkaline fluid until the hydrogel binder dissolves or breaks down at the location targeted for release of alkalinity for the purposes of CO₂ sequestration. Such natural alkaline fluids can also have high temperatures at the point of extraction, which can be advantageous if used in the production of substrates that are aggregated, for example, with cementitious and/or polysaccharide hydrogels by reducing the heat input required to activate and/or cure these binders. Their characteristically high concentration of divalent cations and alkalinity can also speed the activation and/or curing process of cementitious and/or hydrogel binders, among other mechanical and chemical binders, used in the production of substrates engineered for CO₂ sequestration.

In some embodiments, forming the substrate may include incorporating the alkaline liquid into at least one of a solid or semi-solid structure. For example, the alkaline fluid may be used to form a solid substrate by freezing the alkaline fluid into solid blocks or otherwise, solid structures. In some embodiments, such frozen solid structures may be formed solely by freezing one or more alkaline fluids into the solid substrates. In some embodiments, naturally occurring organic materials (e.g., husk, hemp, wood chips, straw, or any other organic or biobased naturally occurring material described herein) may be suspended in, or otherwise mixed with the alkaline fluid and the mixture, suspension, or slurry may be subsequently frozen to form a solid substrate including the alkaline fluid and the naturally occurring organic material suspended therein.

In some embodiments, forming the substrate may include incorporating the alkaline fluid into a porous solid substrate. For example, the alkaline fluid may be absorbed by woody biomass which would then be retained in the pore space of the floating biomass either in liquid or in subsequently precipitated solid form, and ultimately released to the water body through leaching and/or dissolution once the woody biomass has floated, and/or been transported and/or released to the target location.

In some embodiments, the alkaline fluid may be frozen to form the solid substrate as described herein on shore, and then stored in freezers on board a transport vessel to be delivered to a target location. In some embodiments, the alkaline fluid may be frozen to form the solid substrate on transport vessels using onboard freezers. In some embodiments, the alkaline fluid may be delivered to cold regions of the world (e.g., to the Arctic Ocean, Antarctic Ocean, Greenland Sea, Barents Sea, Beaufort Sea, Kara Sea, Laptev Sea, East Siberian Seas, Weddell Sea, Ross Sea, Baltic Sea, or any other cold-water body), and the naturally cold environmental temperatures of such regions may be used to freeze the alkaline fluid to form the substrate. In some embodiments, the substrates including the frozen substrates may be used as floating substrates in cold oceans with average air and/or water temperatures slightly above freezing. The alkaline fluids may naturally melt over time (e.g., could be faster, slower, or same timeline as the dissolving of natural/carbonate buoys), which releases the alkaline fluid into the ocean.

Accordingly, alkaline fluids may be used as a payload or at least a portion of a payload for ocean-based CDR as described in detail in the ‘339 PCT and/or the ′326 provisional.

With continuing reference to FIG. 1, in some embodiments, the method 10 may optionally, include assembling multiple substrates (e.g., multiple solid substrates) into a substrate assembly, at 20. For example, 10's, 100's, or even 1,000's of any of the solid substrates, semi-solid substrates, or solid substrates filled with or including alkaline fluids may be coupled, joined, or assembled together to form a substrate assembly. In some embodiments, multiple substrates may be aggregated or otherwise coupled to each other (e.g., via the coating disposed on the substrates, joined using naturally occurring organic materials, binders, etc.) to form an aggregate or array of substrates (e.g., seeded and/or coated substrates, and/or substrates including alkaline fluids) that are deployed together in the body of water, as described herein. Such assemblies, aggregates, or arrays may be formed by coiling, chaining (e.g., via twines, ropes, or chains), stacking, or coupling together in any suitable arrangement to form the aggregate. The aggregates may advantageously have higher mechanical strength than individual seeded substrates. Moreover, forming aggregates may also advantageously at least partially shield adjacent seeded substrates included in the aggregate from waves, currents, and wind action, thereby inhibiting removal, erosion, and/or breakage of the seeded target product, fertilizers, nutrients, additives, or binders from the seeded substrate. In some embodiments, the carbonaceous coating may be used to form aggregates of the coated substrate. For example, the CaCO₃ based coating may be used to not only coat, but also to aggregate individual substrates into a larger, composite mass of substrates and coating. Such aggregates be useful when a larger sized float is desired, for example, to serve as a larger, more buoyant, and/or longer floating substrate for supporting the growth of larger, and/or longer-lived target product. Such linked substrates may also be used to create large, high-density aggregates of substrate and coating materials to be rapidly sunk from the surface body of water to the floor of the body of water (e.g., sea floor).

While the method 10 is described above as optionally including assembling multiple substrates into a substrate assembly, such as process can be performed for any suitable payload for ocean-based CDR and is not limited to assembling substrates specifically. For example, any number of payloads can be assembled in any suitable structure or the like that can at least temporarily maintain the payloads in a relatively compact or connected assembly. In some implementations, such an assembly, structure, etc. can be configured to release the payloads over a desired time or in response to satisfying a desired criterion. Such a criterion may be, for example, the dissolution and/or degradation of one or more portions of the assembly; the breaking up of one or more portions of the assembly as a result of heavy seas, waves, or currents; the breaking up of one or more portions of the assembly as a result of mechanical damage from passing ships, marine vessels, large marine animals, etc.; exposure to sunlight or ultraviolet radiation; and/or the like.

As described above with reference to step 12, the method 10 includes deploying the payload such as those described above at a first location in a body of water (e.g., an ocean, a sea, a river, a pond, a lake, a river, or any other body of water from which the substrate can travel to a second location). In some embodiments, the first location may include at least one of a shore, a dock, a pier, an offshore platform, an offshore location, a manned vessel, or an unmanned vessel. In some embodiments, deploying the payload may include deploying a large number of payloads independently into the body of water. In some embodiments, deploying the payload may include assembling a large number of payloads into a payload assembly (e.g., a substrate assembly having any number of solid substrates at least temporarily coupled together) and deploying the payload at the first location in the body of water. The payloads may be deployed at the first location using any suitable means, method, mechanism, etc. In some embodiments, for example, the substrates may be deployed from shore, a dock, a pier, an offshore platform (e.g., an oil rig), a manned vessel (e.g., a ship, a cargo ship, a launch, etc.), or an unmanned vessel (e.g., a drone). In some embodiments in which unmanned vessels are used, such vessels may be recoverable, or sacrificial vessels. For example, the vessels may be formed from or include biodegradable materials such that once such unmanned vessels deliver or deploy the payloads at the first location, the unmanned vessels may eventually sink to the bottom of the body of water and not have to be recovered.

Any of the payloads described herein may be in a first configuration when deployed at the first location. For example, in embodiments in which the payload is a substrate (e.g., a solid substrate including naturally occurring organic material, seeded with target product, including carbonaceous material or coating, and/or alkaline fluids), a buoyancy of the substrate in the first configuration may be greater than a threshold buoyancy allowing such substrates to float, as described herein. Said another way, a density of the substrate in the first configuration can be less than an average density of the water in which the substrate is deployed, thereby allowing the substrate to float near, at, or on a surface of the water. In some embodiments in which the substrate includes carbonaceous materials or alkaline fluids, the carbonaceous materials or alkaline salts included in the alkaline fluids may be substantially unreacted (e.g., have not yet neutralized protons present in the body of water) in the first configuration. For example, the substrates may be configured to dissolve, disintegrate, or sink after a designated time.

In some embodiments, the substrates may be deployed at the first location using automated rigging or just-in time assembly. In some embodiments, the storage and/or deployment of the substrate or substrate assemblies may be miniaturized or containerized, such that the deployment can be contracted to occur from a third-party vessel (e.g., a shipping vessel that is already crossing a region of the ocean at which the first location is located).

In some embodiments, the methods described herein may include transporting and/or assembling a large number of payloads sufficient to capture and sequester atmospherically significant amounts of CO₂. For example, the methods described herein may include transporting and/or assembling a large number of substrates sufficient to cultivate and/or accumulate an amount of target product biomass that is atmospherically significant and/or relevant for carbon capture applications, and/or sufficiently large amounts of carbonaceous coated substrates or solid substrates including alkaline fluids to neutralize acidity of the ocean and sequester carbon. In such embodiments, deployment systems used to deploy the substrates at the first location can include one or more high density modules, components, and/or stacks that enable storing, transporting, and/or deploying large quantities of substrates within a small and/or limited footprint (e.g., a small area, volume and/or weight occupied). For example, in some embodiments, the deployment systems can be configured to transport, store, assemble, and/or deploy at least about 100,000 substrates, at least about 200,000 substrates, at least about 400,000 substrates, at least about 800,000 substrates, at least about 1,000,000 substrates, at least about 1,500,000 substrates, at least about 2,000,000 substrates, at least about 2,500,000 substrates, at least about 3,000,000 substrates, or more, inclusive of all values and ranges therebetween. In some embodiments, the deployment systems described herein as being used for ocean-based CDR can be similar to and/or substantially the same as any of the deployment systems (including portions or combinations thereof) described in International Patent Application No. PCT/US2023/061782 (the “′782 PCT”), filed Feb. 1, 2023, entitled “Systems, Devices, and Methods for Rapid and Scalable Deployment of Marine-Based Cultivation Apparatus,” the entire disclosure of which is incorporated herein by reference.

In some implementations, the CDR payloads described herein can be deployed from a vessel. The vessel can be any suitable floatable vessel, watercraft, boat, ship, raft, etc. that can be operated in or on a body of water. In some implementations, the vessel can be a large cargo ship, tanker, and/or other commercial-scale vessel, and may be manned or unmanned. The vessel can accommodate, house, and/or contain one or more components of the deployment system, including, the storage component, the longline, the cultivation component, and/or the assembly component. The vessel can be configured to transport the one or more components of the payload to and from a loading location (e.g., a shipping dock and/or port in which the components of the system can be loaded and unloaded) and one or more location (e.g., the first location) designated for deployment of the substrates, as further described herein.

The vessel can be controlled (e.g., via human input, semi-autonomously, or autonomously) to place and/or position the vessel near, adjacent, and/or parallel to one or more suitable locations for loading and unloading cargo, such as a shipping dock, port, wharf, pier, embarcadero, and/or the like to allow the loading and/or unloading of CDR payloads or components or portions thereof. In some embodiments, the vessel can include one or more areas configured to deploy the payloads at the first location (e.g., payloads including substrates seeded with a target product, coated with or otherwise including carbonaceous and/or alkaline materials, and/or alkaline fluids). Moreover, the vessel can include any suitable storage system, cultivation system, assembly system, deployment system, and/or any other suitable system configured to store, prepare, assemble, seed, and/or deploy substrates and/or other payloads into the body of water.

In some embodiments, deploying the payload includes delivering an alkaline fluid to the first location in the body of water in liquid form. In some embodiments, deploying the payload includes delivering an alkaline fluid to the first location in the body of water in liquid form. For example, any of the alkaline fluids described herein may be deployed at the first location in the body of water using any suitable means, methods, or mechanisms such as, for example, using buoys, shipping vessels, barges (e.g., flexible barges), wells, pipelines, canals or aqueducts, any others suitable means, methods, and/or mechanisms, or any suitable combination thereof. Examples of such transport or deployment systems or methods are described in detail in the ‘339 PCT and/or the ′326 provisional incorporated by reference above. In some implementations, using alkaline fluid may increase the efficiency of transporting alkalinity to target sites for CO₂ sequestration by maintaining it in a fluid state, as compared with transport in a solid state, thereby allowing for transport by the efficient methods of buoys, shipping vessels, flexible barges, wells, pipelines, and canals or aqueducts, etc.

Referring back to FIG. 1, the method 10 also includes allowing the payload to be carried by and/or to otherwise travel via natural water currents to a second location in the body of water while the payload transitions from a first configuration to a second configuration during travel from the first location to the second location to facilitate atmospheric carbon sequestration, at 22. In some embodiments, the second location may be the deep ocean where the payloads (e.g., any of the solid substrates or alkaline fluids described herein) are transported and/or carried passively under natural water currents and the sequestered carbon is transferred from the fast to the slow carbon cycle. In some embodiments, a buoyancy of the payload may also adjust or change as it transitions from the first configuration to the second configuration, as described herein.

In some embodiments, the first location (e.g., a shore, a dock, a pier, an offshore platform, an offshore location, a manned vessel, an unmanned vessel, or any other suitable location) may be selected based at least in part on an estimated travel time for the payload to arrive at the second location passively under the natural water currents. For example, the first location may be selected based at least in part on the estimated travel time and a predicted trajectory of the payload through the body of water from the first location to the second location. In some embodiments, the first location may be additionally, or in the alternative, be selected based at least in part on the estimated travel time, the predicted trajectory, and at least one of environmental conditions, ocean chemistry, regions of fish or marine mammal migration, or shipping traffic along the predicted trajectory.

In some embodiments, the first location may be selected using one or more machine learning models configured to perform geospatial modelling, numerical modelling, and/or models of forecasted spatial evolution or direction of the payload(s) under the influence of ocean currents, wind, tide strength, and in some implementations, using in situ ocean circulation data measured using satellite imagery, or via sensors integrated into the payload(s) (e.g., GPS sensors, pressure sensors, wind flow sensors, temperature sensors, any other suitable sensors, or a combination thereof included in a buoy, substrate, and/or cultivation apparatus) to estimate the travel time and/or predicted trajectory from the first location to the second location, and thereby select the first location accordingly.

For example, the second location can be a target location in the water body having a predetermined and/or desired set of characteristics and the first location can be selected (e.g., using machine learning models and/or any other model or computational tool) in a manner that will allow the CDR payload to travel from the first location to the second location. For example, predetermined and/or desired characteristics of the second location can include upper temperature limits, upwelling regions/zones, downwelling regions/zones, predicted efficiency and/or effectiveness of the CDR payload to sequester CO₂ and/or neutralize acidification of the water body, and/or the like. In some implementations, determining a target location (e.g., the desired second location) and thus, determining a corresponding deployment location (e.g., the desired first location) can be based on collected and/or historical data associated with the body of water, environmental conditions, deployment methods, and/or any other suitable data. In some implementations, one or more machine learning models and/or the like can be trained and executed to analyze such data and to provide a predictive output associated with the first location, the second location, and/or a trajectory of the CDR payload traveling therebetween. For example, any of the embodiments and/or methods described herein can use and/or can execute models and/or algorithms similar to or substantially the same as any of those (or portions thereof) described in the ‘339 PCT and/or in U.S. patent application Ser. No. 17/957,681 (the “'681 application”), filed Sep. 30, 2022, entitled “Systems and Methods for Quantifying and/or Verifying Target Product Accumulation for Greenhouse Gas Sequestration,” the entire disclosure of which is incorporated herein by reference.

In some embodiments, the buoyancy of the payload (e.g., substrate) in the first configuration may be greater than a threshold buoyancy, and a buoyancy of the payload (e.g., substrate) in the second configuration is less than the threshold buoyancy. For example, the payload may be or may include a solid substrate that includes a naturally occurring product as described herein, and that may include a target product, and that is positively buoyant, i.e., floats in water as previously described. In contrast, the target product cultivated on the substrate may be naturally negatively buoyant (i.e., sinks in water) or may become increasingly negatively buoyant as the target product matures. The buoyancy of the payload is therefore based on the buoyancy of the substrate and the buoyancy of the target product incorporated therein. In the first configuration, the target product, which may or may not be partially grown before deployment in water, may have a first biomass having a first amount of negative buoyancy that is less than a first amount of positive buoyancy of the substrate. Thus, in the first configuration, the payload (e.g., substrate and cultivated biomass) has an overall positive buoyancy such that the substrate floats on the body of water when initially deployed.

Over a period of time, the target product accumulates biomass as it captures, absorbs, and/or sequesters atmospheric CO₂ and grows. The accumulation of biomass, in turn, increases an amount of negative buoyancy associated with the target product. Moreover, water may accumulate within the porous substrate reducing the positive buoyancy of the substrate. Once a threshold amount of biomass of the target product is accumulated, the threshold amount of biomass may have a second amount of negative buoyancy that is greater than the first amount of positive buoyancy of the substrate, causing the substrate to have a buoyancy that is less than the threshold buoyancy, which is based at least in part on the degree or amount of negative buoyancy associated with the threshold amount of biomass accumulation. Thus, in the second configuration, the substrate may sink below surface carbon cycles (e.g., to the floor of the body of water), thereby trapping and/or sequestering the captured carbon within the body of water and/or within sediments (e.g., below the surface carbon cycles). Since the substrate includes naturally occurring materials and the target product includes naturally occurring organisms, the substrate has a negligible impact on the environment (e.g., a marine environment), and, in some instances, may improve the environment by providing a nutrition source for animals and organisms that may reside near the floor or bottom of the body of water.

In some embodiments, the substrate may transition from the first configuration to the second configuration via removal or degradation of at least portions of the substrate. For example, the naturally occurring product included in and/or forming at least a portion of the substrate (or one or more base layers, binders, coatings, etc. thereof) may be naturally biodegradable (e.g., via hydrolysis and/or enzymatic digestion by organisms that may be naturally present in the water), may be degradable due to exposure to ultraviolet (UV) radiations of the sun, and/or may be dissolvable in water (e.g., via inclusion of calcium carbonate or other cementitious products that are dissolvable in water). Degradation of the substrate or portion(s) thereof may occur over a period of time causing the positive buoyancy of the substrate to decrease, while the negative buoyancy of the target product seeded therein increases as it grows until the buoyancy of the substrate decreases to be less than the threshold buoyancy causing and/or otherwise allowing the seeded substrate to sink in the body of water.

In some embodiments, the substrate may be hollow (e.g., include or define a void or internal cavity therein) and a stopper, plug, or cap may seal the internal volume/cavity from the external environment. The stopper, plug, or cap may be configured to degrade over time, for example, via hydrolysis, chemical dissolution, disaggregation, UV radiation, and/or galvanic corrosion such that water may enter the internal cavity thereby, causing the buoyancy of the substrate to decrease below the threshold buoyancy, as previously described. It should be appreciated that any of the substrates described herein may be configured to transition from the first configured to the second configuration using any combination of the transition mechanisms described herein with respect to the method 10.

In some embodiments, at least a portion of the substrate (or other payload) may be coated with a carbonaceous and/or alkaline material, as previously described herein. In such embodiments, the coating may be configured to cause the substrate (or other payload) to transition from the first configuration to the second configuration. Moreover, a first volume of the coating in the first configuration may be greater than a second volume of the coating in the second configuration. The coating may be formulated to neutralize acidification of the body of water and/or to sequester carbon from the atmosphere or surface waters as it dissolves in the body of water causing the substrate to transition from the first configuration to the second configuration.

For example, in the first configuration the coating may have a positive buoyancy sufficient to cause the substrate to have a positive buoyancy and causing the substrate to float. In the second configuration, the buoyancy of the coating may decrease causing the substrate to also have a negative buoyancy and sink, for example, to sequester carbon captured by the target product as it grows and/or by the coating, as described herein. In some embodiments, the coating may have a first volume in the first configuration, which is greater than a second volume of the coating in the second configuration. For example, the coating may dissolve or disintegrate in the body of water over a period of time, thus losing volume and causing the buoyancy of the substrate to reduce until the substrate sinks into the body of water. In some embodiments, the coating may also be formulated to sequester carbon from the atmosphere as it transitions from the first configuration to the second configuration.

Expanding further, the composition of the coating and/or its thickness may control buoyancy and therefore, float time of substrate (e.g., ranging from prompt sinking to years of floating). In some embodiments, the coating may be formulated to extend float time of the substrate, for example, by adjusting coating and/or substrate composition and/or thickness to delay uptake of water into the buoyant substrate. The coating may gradually dissolve, causing loss of buoyant fraction of aggregate and allowing water to diffuse into substrate, eventually sinking the substrate, for example, after the coating has sufficiently dissolved or disintegrated in the body of water. In some instances, increasing float time of substrate may promote settlement and growth of the target product on the substrate, which will sequester CO₂ via photosynthesis and will be transported to a bottom of the body or water (e.g., seabed, ocean floor, etc.) when the coating partially or wholly dissolves. For example, the partially or wholly dissolved coating can allow water to intrude the floating substrate, which can result in the combined mass (e.g., substrate and target product) sinking.

The coating may remain on the substrate at time of sinking, thereby inhibiting biological decomposition of substrate, and/or reducing release (e.g., via remineralization) of CO₂ previously sequestered in the substrate as organic carbon. In some embodiments, to shorten float time and accelerate sinking, the coating composition and/or thickness may be optimized to make the coated substrate negatively buoyant such that the substrate sinks upon deployment in the body of water (e.g., ocean or other natural or man-made water body).

In some embodiments in which the substrate includes a frozen alkaline fluid, the alkaline fluid may have a positive buoyancy in the solid form, and as the alkaline fluid melts it, the alkaline fluid mixes with the body of water to reduce its alkalinity, as previously described. Similarly, when alkaline fluid is deployed in the body of water in liquid form, the alkaline fluid may mix with the water while being transported and/or carried by or under natural water currents to the second location, as described in the ‘339 PCT and/or the ′326 provisional.

In some embodiments in which the substrate or substrate assemblies include a solid substrate(s), such substrate or substrate assemblies may include sensors for data collection as well as communication equipment (e.g., GPS transponders, transceivers, transponders, etc.) that may allow the substrate or assemblies thereof to collect and transmit data. Such sensor may, for example, be used for economic data collection (e.g., shipping traffic), environmental data collection, or defense sensing. In some embodiments, the substrate(s) or substrate assemblies may be commercialized. For example, the substrate(s) or substrate assemblies may be directly commercialized by the deployer of the substrate(s) or substrate assemblies by sequestering carbon and/or increasing the alkalinity of the body of water (e.g., the ocean) and selling carbon credits, commercialized as a service (e.g., a third party pays the deployer to deploy the substrate(s) or substrate assemblies and selling carbon credits), and/or commercialized as contracting (e.g., a third-party pays the deployer to deploy substrate(s) or substrate assemblies that include ocean fertilizing materials that serve as feedstock for local fish population for fish stock restoration).

In some implementations, the operations and/or steps of the method 10 from forming the substrate(s) to the substate transitioning from the first configuration to the second configuration may have a net negative carbon footprint. In other words, the amount of carbon sequestered by the substrate(s) may substantially exceed an amount of carbon released during the formation and deployment of the substrates such that the sum of the carbon footprints of all the processes of the method 10 may have a negative carbon footprint.

Expanding further, in some embodiments in which the substrate is seeded with the target product, the forming, the seeding, and the deploying the substrate has a combined first positive carbon footprint, transitioning of the substrate from the first configuration to the second configuration has a second negative carbon footprint, and the sum of the first positive carbon footprint and the second negative carbon footprint is a net negative carbon footprint. In some embodiments, in which the substrate is coated with a carbonaceous coating, the forming, the coating, and the deploying, the substrate has a combined first positive carbon footprint, transitioning of the substrate from the first configuration to the second configuration has a second negative carbon footprint, and the sum of the first positive carbon footprint and the second negative carbon footprint is a net negative carbon footprint.

In some embodiments in which the substrate is coated with the carbonaceous coating and seeded with the target product, the forming, the coating, the seeding, and the deploying, the substrate has a combined first positive carbon footprint, transitioning of the substrate from the first configuration to the second configuration has a second negative carbon footprint, and the sum of the first positive carbon footprint and the second negative carbon footprint has a net negative carbon footprint. In some embodiments, in which the substrate includes an alkaline fluid, the process of extracting or forming the alkaline fluid, and deploying the alkaline fluid at the first location may have a first positive carbon footprint, the transitioning of the alkaline fluid from the first configuration to the second configuration (e.g., mixing with ocean water to reduce alkalinity and sequester carbon) may have a second negative carbon footprint, and the sum of the first positive carbon footprint and the second negative carbon footprint is a net negative carbon footprint. Thus, any of the substrates described herein may be used in the method 10 such that they have a net negative carbon footprint that eventually leads to reduction in the global carbon footprint via transitioning of the carbon from the slow to the fast carbon cycle in a process that has a net negative carbon footprint.

Referring back to FIG. 1, the method 10 further includes quantifying an amount of the atmospheric carbon sequestration, at 24. For example, the amount of atmospheric carbon sequestration can be based at least in part on the transport of the payload, the release, degradation, and/or dissolution of at least a portion of the payload, the transitioning of the payload from the first configuration to the second configuration, the sinking of at least a portion of the payload with or without an amount of accumulated biomass, and/or the like. In some implementations, carbon sequestered via ocean-based CDR embodiments and/or methods herein can be quantified, calculated, and/or valued, and a credit tied to and/or otherwise associated with the calculated amount of carbon sequestered allowing for the sale of carbon offset credits and/or the like in a carbon credit market (or any other suitable market). In some implementations, the quantification, verification, and/or calculation of an amount of biomass accumulation and/or an amount of carbon captured by a payload (with or without target product accumulation) can be performed using any of the systems and/or methods, for example, described in detail in the '315 patent and/or the '681 application.

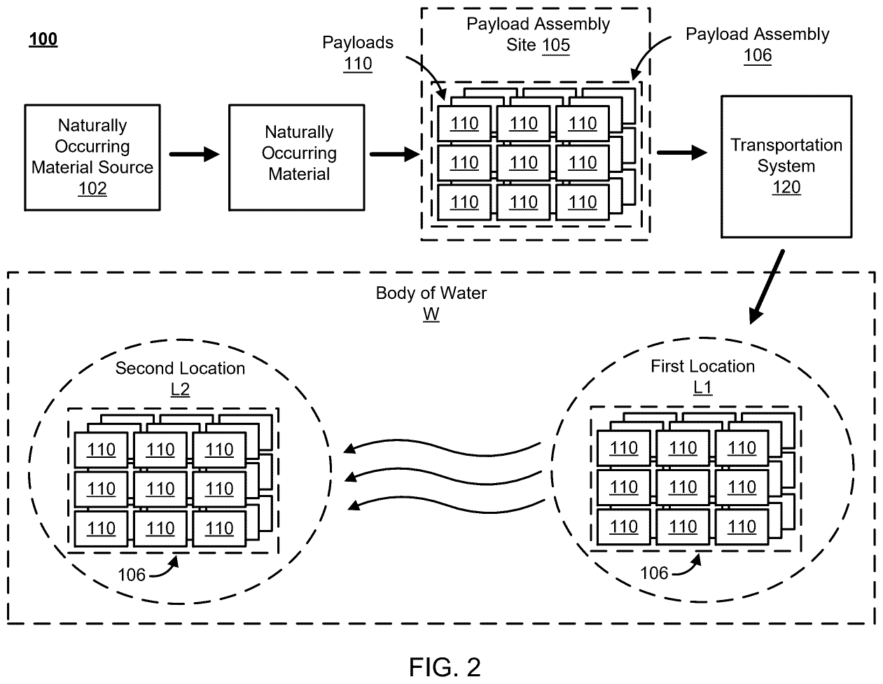

FIG. 2 is a schematic block diagram of a system 100 for water-based (e.g., ocean-based) CDR according to an embodiment. The system 100 is configured to extract, produce, manufacture, and/or otherwise provide one or more payloads 110 that can be deployed into a body of water W and configured to capture carbon from the fast carbon cycle as the payload is passively transported from a first location L1 to a second location L2 in the body of water W, and to sequester the carbon by transferring it to the slow carbon cycle.

As shown in FIG. 2, the system 100 includes a naturally occurring material source 102 from which a naturally occurring material may be obtained and used to generate and/or form at least a portion of the payload 110. In some implementations, the naturally occurring material source 102 may be a source of organic material that is readily available in natural environments, or that is produced naturally as the main product or byproduct of farming or other cultivating/harvesting operations. In such embodiments, the naturally occurring material can be used to form, for example, any number of substrates that may independently form the payload 110 or that may optionally between seeded or imbued with a target product that can be cultivated to grow and accumulate biomass. For example, the naturally occurring material may include an agricultural waste product or a forest waste product. In various embodiments, the naturally occurring material may include, but is not limited to biomass (e.g., woody biomass) such as, for example, to grasses (e.g., switch grass, wild grass, genetically modified grass, etc.), wood chips (e.g., obtained from downed trees or wood reclamation operations), wood rounds, tree bark, forestry residue (saw dust, twigs, needles, leaves, cones, seeds, nuts), wood excelsior fibers, straw fibers, hog fuel, corn cobs, coconut shells, coconut fibers, hemp, jute, compost, xanthan gum, agar, alginate, cardboard or nanocellulose fibers, paper, etc. In some embodiments, the naturally occurring material may be a biobased material, or biodegradable polymer (e.g., polyhydroxyalkanoate based aliphatic polyesters such as PHA or PHB) produced from natural materials such as sugar, oils, molasses, coconut oil, palm oil, chitin, mycelium, etc. The naturally occurring materials (e.g., the biomass, biobased material, biodegradable polymers, etc.) may be formulated to naturally biodegrade in water (e.g., freshwater, saltwater, brackish water, etc.), for example, via hydrolysis and/or enzymatic digestion and/or otherwise formulated to lose buoyancy over time. In such embodiments, the naturally occurring material source 102 may include farms, paper recycling facilities, sawmills, compost or lawn waste collectors, logging operations, manufacturing plants, or any other source from which the aforementioned naturally occurring materials, or any naturally occurring material as described with respect to method 10 may be obtained.

In some implementations, the naturally occurring material source 102 may be a source of carbonaceous material, alkaline material, and/or the like that may be included in or coated on the substrate(s) to form the payload(s) 110 or that may form the payload 110 independent of the substrate(s) described above. In such implementations, the naturally occurring material source 102 may include, but is not limited to a source of CaCO₃, CaMg(CO₃)₂, MgCO₃, CaO, Ca(OH)₂, Mg(OH)₂, MgO, KOH, NaOH, and/or alkaline mafic/ultramafic metal silicate minerals and/or rocks, organic and/or inorganic product or waste product, or any other and/or any other carbonaceous and/or alkaline material described above with reference to method 10, and/or any combination(s) thereof. Such naturally occurring material can be configured to sequester CO₂ via ocean alkalinization, to neutralize ocean acidification to enhance the ocean's ability to sequester CO₂, to at least temporarily provide buoyancy for the payload 110 (e.g., a substrate), and/or the like. In some implementations, the naturally occurring material source 102 may also be a source of material including a silicic fraction, for example, pumice and/or other low density vesicular rock (e.g., mafic rock, ultramafic rock, and/or minerals) to enhance buoyancy of the substrate coating and/or the payload 110.

In some embodiments, the naturally occurring material source 102 may be a source of alkaline material that may be mixed with a surfactant foam to create an aerated final material. In some embodiments, the alkaline naturally occurring material may include a metal oxide fraction such as, for example, iron oxide (Fe₂O₃) and/or other iron (Fe) or manganese (Mn) bearing oxide(s) (e.g., to adjust buoyancy, for ballast, and/or to control orientation of substrate when included one side of the substrate). In some embodiments, the naturally occurring material may include one or more organic or inorganic binders, for example, to hold the carbonaceous material together and adhered to the substrate. Suitable binders may include, but are not limited to carbonate binders (e.g., CaO, Ca(OH)₂, etc.), MgO, Mg(OH)₂, and/or other cementitious binder, or organic binders, for example, organic resin, polysaccharide gel, proteinaceous binder, adhesive, any other suitable organic binder, or combination thereof. In some embodiments, the naturally occurring material may include an accelerant to increase or decrease the rate of hydration and/or mineralization of the alkaline material. In any of the aforementioned embodiments that include carbonaceous and/or alkaline materials, the naturally occurring material source 102 may include mines, seashells, shellfish, corals, rocks, recyclers of carbonaceous salts, or any other source of the carbonaceous material.

In some embodiments, the naturally occurring material source 102 may be a source of an alkaline fluid, for example, aqueous solutions of alkaline salts such as, for example, calcite, chrysolite, dolomite, hydromagnesite, ikaite, magnesite, monohydrocalcite, nesquehonite, sodium carbonate, thermonatrite, anorthite, diopside, forsterite, jennite, larnite, rankinite, tobermorite, wollastonite, brucite, lime, periclase, portlandite, CAH10, C2AH8, C3AH6, C4AH13, C2FH8, C3FH6, C4FH13, tricarboaluminate, anorthite, forsterite, gehlenite, larnite, merwinite, rankinite, any other suitable alkaline mineral and/or fluid, or a combination thereof as described in detail with respect to the method 10. In such embodiments, the naturally occurring material source 102 may include surface waters, shallow subsurface waters, hydrothermal brines, deep subsurface waters, oil field brines, evaporite brines, or any other sources described with respect to the method 10 and may be extracted using conventional well-drilling, recirculation, surface collection, solution mining, mining of mafic or ultramafic rocks using supercritical CO₂, CO₂ bearing fluids or air, or using any other suitable extraction method, as described in the ‘339 PCT.

The system 100 also includes a payload assembly site 105 for assembling one or more payloads 110 (e.g., from the naturally occurring material obtained from the naturally occurring material source 102). For example, in some embodiments, the payload 110 can be substrate(s) that may include and/or be formed of a naturally occurring material (e.g., any of the organic and/or biodegradable materials described herein). In such embodiments, the payload assembly site 105 may include equipment or machinery to form or manufacture the substrates into solid or porous blocks having any suitable shape (e.g., square, rectangular, round, oval, triangular, polygonal, asymmetric, or having any other suitable shapes or combination thereof). In some embodiments, the solid or porous substrates can be formed into or disposed within tubes, tube-like structures, meshes, socks, bags, pouches, bailers, and/or any other container-like structure defining an internal volume. In some embodiments, the solid or porous substrates can include and/or can form over braids, spiral wraps, wattles, slit socks, ropes (e.g., similar to those used to prevent land erosion, or flood barriers), sheets (e.g., single or multilayered), meshes, rovings, and/or the like or combination(s) thereof, as previously described herein. Moreover, the payload assembly site 105 may include, but is not limited to, conveyor belts (e.g., for transporting the naturally occurring materials), bailers, compressors (e.g., mechanical or hydraulic compressors), molds, knitting equipment, sewing equipment, gas pressure fillers (e.g., air compressors), mixers (e.g., to mix binders with the naturally occurring materials), heaters (e.g., for thermoplastic processing), boilers, and/or any other suitable equipment or machinery, or combination(s) thereof to form the naturally occurring materials into substrates having a desired structure.

In some embodiments in which the substrate includes a carbonaceous and/or alkaline material or coating, the carbonaceous and/or alkaline material may be incorporated into the solid or porous structure forming the substrate (e.g., included with the naturally occurring material during the manufacturing process of the substrate or imbued or embedded in the substrate), or coated on at least a portion of the substrate, as described herein. In such embodiments, the payload assembly site 105 may include carbonaceous and/or alkaline material handling equipment including, but not limited to conveyors, mixers (e.g., to mix binders with the carbonaceous materials), heaters, boilers, coating equipment (e.g., spray coaters or dip coaters), or any other suitable equipment to coat or otherwise incorporate the carbonaceous materials into the substrate having a solid structure.

In some embodiments, a target product (e.g., any of the target products described herein) may be incorporated, embedded, and/or directly seeded in the substrate(s) or portion(s) thereof. In such embodiments, the payload assembly site 105 may additionally, or alternatively, include target product culturing or growth equipment such as, for example, hatcheries, culture pools or ponds, lighting, storage (e.g., for storing fertilizers, culture mediums, and/or nutrients), heaters, temperature sensors, or any other equipment or machinery or combination thereof to facilitate culture or cultivation of the target product and/or incorporation of the target product into the substrate. Examples of such hatcheries or equipment may be similar to or substantially the same as any of the embodiments or concepts described in detail in the ‘782 PCT and/or International Patent Application No. PCT/US2021/054952 (the “′952 PCT”), filed Oct. 14, 2021, entitled “Systems and Methods for the Hatching, Seeding, and/or Cultivating of a Target Product,” the entire disclosure of which is incorporated herein. In some embodiments, such hatcheries and/or equipment can be included in and/or a part of a vessel (e.g., a shipping vessel) and/or the like, as described in the ‘782 PCT, the ‘339 PCT, and/or the ′326 provisional.

In some embodiments, the payload 110 (without or without a substrate) may include an alkaline material (e.g., an alkaline mineral or fluid such as any of those described herein) that is intended to be communicated to the body of water W. For example, in some implementations the substrate may include an alkaline material in liquid form that is released into the body of water W, as previously described herein. In some implementations, the alkaline material (e.g., alkaline liquid) that is released into the body of water W independent of or in conjunction with (but not necessarily an integrated part of) the substates. In such implementations, the payload assembly site 105 may include conduits (e.g., pipes, tubes, hoses, etc.) configured to receive or transport the alkaline fluids, mixers, storage containers, pressure sensors, temperature sensors, controllers, pumps, valves, fillers, any other suitable equipment or combination thereof, for example, to allow transportation of the alkaline fluid to the first location L1 (e.g., fill storage compartments of manned, unmanned, or autonomous vessels, or buoys with the alkaline fluid). In some embodiments, the payload assembly site 105 may be configured to form the alkaline fluid into a frozen solid substrate. In such embodiments, the payload assembly site 105 may additionally, or in the alternative, include freezers, molds, mixers, casters, or any other suitable equipment or combinations thereof to allow formation of the alkaline fluids into a frozen substrate (e.g., solid block frozen alkaline fluid or incorporated with naturally occurring material in frozen form, as previously described).

In some embodiments, the payload assembly site 105 may allow for the assembly of any number of individual payloads 110 into a payload assembly 106. For example, multiple payloads 110 (e.g., including naturally occurring materials, biodegradable materials, carbonaceous materials, target product(s), alkaline minerals, alkaline fluids and/or frozen alkaline fluid(s)), etc., may be coupled, connected, linked, and/or otherwise assembled together to form rafts or other floating assemblies (e.g., the payload assemblies 106) that can be deployed at the first location L1. In some embodiments, the payload assembly site 105 may include ropes, chains, hooks, stackers, lifts, forklifts, bailers, or any other suitable equipment configured to couple, connect, or link the multiple payloads (e.g., substrates) to form the payload assemblies 106. The payload assemblies 106 may be coupled together so as to be arranged in a horizontal array, a vertical array, a rectangular array, a circular array, any other suitably shaped or sized array, or a combination thereof.

As shown in FIG. 2, the system 100 may also include a transportation system 160 to transport the payloads 110 and/or the payload assemblies 106 including multiple payloads to the first location L1 and deploy the payloads 110 or the payload assemblies 106 into the body of water W. In some embodiments, the transportation system 120 may include a vessel (e.g., a large cargo ship, tanker, and/or other commercial-scale vessel, and may be manned or unmanned), drones, floatable vessel, watercraft, boat, ship, raft, aircraft, etc., configured to transport and deploy payloads 110 or the payloads assemblies 106 at the first location L1. Such vessels may tow the payloads 110 or the payload assemblies 106 or include storage compartments to hold and transport the payloads 110 or the payload assemblies 106 to the first location L1, as previously described herein with respect to the method 10. In some embodiments in which the payload 110 includes alkaline fluids, the transportation system 120 may include buoys, shipping vessels, ballast tanks, barges (e.g., flexible barges), wells, pipelines, canals or aqueducts, any others suitable means, methods, or mechanisms or any suitable combination thereof to transport the alkaline fluid to the first location L1. In some embodiments, the payload assembly site 105 or at least a portion thereof can be disposed or implemented in or on the transportation system 120 (e.g., shipping vessel and/or the like).

The first location L1 is located in the body of water W (e.g., a lake, a river, a sea, an ocean, etc.) and may include at least one of a shore, a dock, a pier, an offshore platform, an offshore location, a manned vessel, or an unmanned vessel. The first location L1 is selected based at least in part on an estimated travel time for the payload 110 or payload assemblies 106 to arrive at a second location L2 in the body of water W passively under the natural water currents (e.g., carried by the natural water currents), as previously described. In some embodiments, the first location L1 may be selected based at least in part on the estimated travel time and a predicated trajectory of the payload 110 or payload assemblies 106 through the body of water from the first location to the second location. In some embodiments, the first location L1 may be selected based at least in part on the estimated travel time, the predicted trajectory, and at least one of environmental conditions, ocean chemistry, regions of fish or marine mammal migration, or shipping traffic that the payload 110 or payload assemblies 106 are expected to encounter along the predicted trajectory. In some embodiments, one or more machine learning models and/or other computational tools can be used to determine and/or predict the first location L1 and/or the second location L2, as described above. In such embodiments, the machine learning model(s) and/or other computational tool(s) can be similar to and/or substantially the same as any of those described in the ‘339 PCT and/or the '681 application.

The payloads 110 are configured to transition from a first configuration to a second configuration during travel from the first location L1 to the second location L2. In some implementations, the transitioning of the payloads 110 can adjust or reduce a buoyancy of the payloads 110 and can sequester atmospheric CO₂ (e.g., by increasing alkalinity of the body of water and/or absorbing atmospheric carbon, as previously described). Thus, the payloads 110 sequester CO₂ and transfer the CO₂ from the fast carbon cycle to the slow carbon cycle, for example, by increasing the alkalinity of the body of water W or sinking to the bottom of the body of water W at the second location L2. In some embodiments, the second location L2 may be the deep ocean where the payloads 110 (e.g., substrates with or without target products and/or alkaline liquids described herein) are transported and/or carried passively by or under natural water currents and the captured carbon is transferred from the fast to the slow carbon cycle.

The net carbon footprint of the system 100 may be negative such that more CO₂ is sequestered by the system 100 than is released into the atmosphere by the collective steps of the ocean-based CDR process and/or method. For example, the naturally occurring material source 102 (including generation of the naturally occurring material and transportation to the payload assembly site 105), the payload assembly site 105 (including receiving the naturally occurring material and manufacturing or assembling the material into the payload(s) 110), and the transportation system 120 (including storing and transporting the payload(s) 110 or payload assemblies 106 to the first location L1) has a first carbon footprint. Moreover, as the payloads 110 displace, disperse, and/or travel from the first location L1 to the second location L2 passively under natural water currents, the payloads 110 transition from the first configuration to the second configuration (e.g., sequester CO₂, experience a reduction in buoyancy causing the payloads 110 to sink at or proximate to the second location L2, and/or dissolve or mix in the body of water W to increase its alkalinity and/or neutralize acidification) so as to have a second negative carbon footprint such that the sum of the first positive carbon footprint and the second negative carbon footprint is a net negative carbon footprint.

Expanding further, obtaining the naturally occurring material from the naturally occurring material source 102 may involve machinery and/or transportation equipment as previously described that may output CO₂ or other greenhouse gases that contributes to a first portion of the first positive carbon footprint. Manufacturing the naturally occurring material into the payloads 110 may output CO₂ or other greenhouse gases, for example, due to transportation of equipment and/or material, burning of fossil fuels, use of electric-grid-powered equipment, production of waste materials or gases, and/or the like, which collectively contribute to a second portion of the first positive carbon footprint. Similarly, the payload assembly site 105 contributes to a third portion of the first positive carbon footprint. The transportation system 120 may contribute to a fourth portion of the first positive carbon footprint, for example, due to transportation vessels burning fossil fuels to transport and deploy and the payloads 110 to the first location L1, transporting and loading the payloads 110 on transport vessels, etc.

Thus, a sum of the first portion, the second portion, the third portion, and the fourth portion yield or result in a positive carbon footprint. However, the negative carbon footprint resulting from the use of the payloads 110 as they transition from the first configuration to the second configuration and capture/sequester carbon is net negative with a magnitude that is substantially greater than the positive carbon footprint portion of the ocean-based CDR process (e.g., at least 1.5 times greater, at least 2.0 times greater, at least 2.5 times greater, at least 3.0 times greater, at least 3.5 times greater, at least 4.0 times greater, at least 4.5 times greater, at least 5.0 times greater, at least 6.0 times greater, at least 7.0 times greater, at least 8.0 times greater, at least 9.0 times greater, or at least 10.0 times greater, inclusive) so that the sum of the first positive carbon footprint and the second negative carbon footprint is a net negative carbon footprint. In this manner, the system 100 results in a net negative impact on the global carbon footprint reducing atmospheric carbon levels, for example, by transitioning carbon from the fast carbon cycle to the slow carbon cycle.

In some embodiments, the system 100 can include one or more devices, components, systems, and/or the like configured to collect data associated with the payloads 110 (or payload assemblies 106), which can be analyzed and/or processed via any suitable compute device, system, and/or the like. In some embodiments, the system 100 can be configured such that one or more sensor devices or buoys are deployed with the payloads, as described in International Patent Application No. PCT/US2022/079746 (the “′746 PCT”), filed Nov. 11, 2022, entitled “Systems and Methods for Monitoring Accumulation of a Target Product,” the entire disclosure of which is incorporated herein by reference. As such, the device(s), sensor buoys, and/or the like can include and/or can be coupled to device(s) configured to sense, detect, and/or monitor any suitable portion(s) and/or characteristic(s) of the payload(s) 110. For example, in embodiments in which the payload 110 is a substrate for cultivating a target product, such a device or sensor buoy can be configured to sense, detect, and/or monitor growth of the target product, biomass generation, biomass yield, environmental characteristics or data, and/or any other data associated with a deployment of one or more substrates. More specifically, such device(s) or sensor buoy(s) can include but are not limited to one or more sensors, cameras (e.g., underwater cameras, fluorometers, and/or other imaging or optical sensing technologies), tracking devices (e.g., a Global Positioning System (GPS) tracking device, Radio-Frequency Identification (RFID) devices, and/or the like), remote sensing devices, telemetry devices, communication devices, and/or any other suitable device such as any of those described in the '315 patent, the '681 application, and/or International Patent Application No. PCT/US2022/079746 (the “′746 PCT”), filed Nov. 11, 2022, entitled “Systems and Methods for Monitoring Accumulation of a Target Product,” the entire disclosure of which is incorporated herein by reference.

In some implementations, including such device(s) in, for example, sensor buoy or the like that is deployed with the substrates can allow collected data associated with the sensor buoy or any number of the substrates to be aggregated, analyzed, calculated, processed, etc. to allow for a determination, estimation, and/or prediction of, for example, historical or current target product growth or growth rates, biomass production, biomass yield, sinking rate(s), location(s) of a deployment, dispersion of a deployment, environmental conditions in an area corresponding to a deployment, estimated travel distance or estimated travel time to second location, and/or any other desired information associated with the substrate and/or a deployment of any number of substrates. Moreover, in some implementations, such information can be used and/or can otherwise inform one or more predictions and/or quantifications associated with carbon capture and/or sequestration rates, quantities, capacities, and/or the like, as described in detail in the '315 patent and/or the '681 application. For example, in some implementations, the system 100 can be configured to execute one or more machine learning models, algorithms, and/or processes that can be used to predict and/or quantify an amount of carbon sequestered by the substrate(s) and the target product cultivated on or by the substrate(s). In some implementations, the system 100 can execute a series of machine learning models that can be used (e.g., collectively or sequentially in which an output of one model is provided as input into another model) to aggregate data from multiple sources and to correlate the data to provide a calculation, quantification, and/or prediction of the amount of CO₂ sequestered by the substrate(s) and the target product cultivated on or by the substrate(s).

In some implementations, the amount of CO₂ removed through alkalinity enhancement can be quantified and/or verified through the measurement and/or prediction of a change in dissolved inorganic carbon (DIC) in the water body before and after alkalinity enhancement and/or by a change in total alkalinity of the water body before and after deployment. In some implementations, such measurements and/or predictions (e.g., via one or more machine learning models and/or other computational tools) can include the use of one or more efficiency factor(s) that describes and/or that is otherwise associated with the increase in dissolved inorganic carbon per unit increase in total alkalinity (e.g., not to exceed an efficiency factor of 1). In cases where the total volume of the alkalinized portion of the water body are known, total CO₂ removed through alkalinity enhancement can be calculated by multiplying the change in the measured concentration of DIC (for a given sample of water) by the total volume (or predicted, estimated, and/or calculated total volume) of the alkalinized portion of the water body. In cases where the volume of the alkalinized portion of the water body is not known (e.g., open systems), but the amount of total alkalinity added to the water body is known, quantifying CO₂ removal and any additional, other, and/or ancillary processes can include the use of conservative chemical tracers, including a concentration and/or ratio of any known element(s) (e.g., Ca²⁺, Mg²⁺, Sr²⁺, Li⁺, Zn², etc.) and/or corresponding isotope(s) (e.g., Ca45, Mg²⁴, Sr⁸⁶, Li⁷, Zn⁶⁷, etc.) within (or added to) the alkaline material, including any concentrations and/or ratios of elements and/or isotopes (or combinations thereof), that exhibit(s) known stoichiometric and/or empirical relationships to alkalinity within the alkaline material and/or, once dissolved, to other relevant components of the aqueous carbonate system (e.g., total alkalinity in solution, dissolved inorganic carbon). In some implementations, the tracer-based approach can allow quantification of relevant and/or associated processes involved in CO₂ removal by alkalinity enhancement without, for example, knowing a total volume of water involved in the process (e.g., so long as a total quantity of alkaline material deployed is known). In some implementations, such a tracer-based approach to quantifying chemical processes associated with CO₂ removal by alkalinity enhancement of aqueous systems can be similar to and/or substantially the same as those described in the ‘339 PCT.

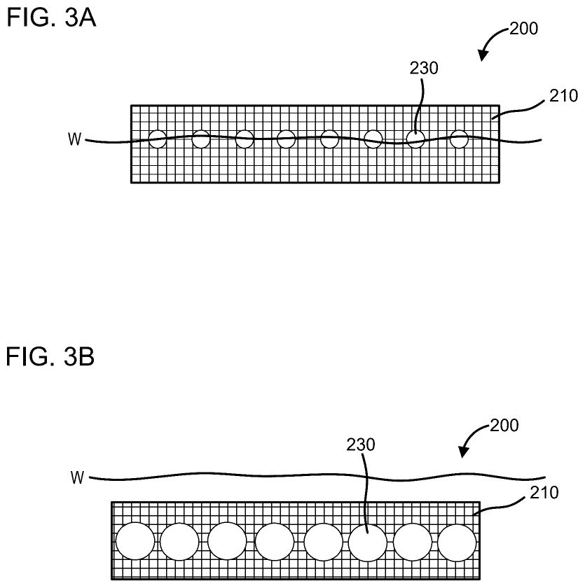

FIGS. 3A-7 show various embodiments of substrates that may be used as cultivation apparatus for sequestering carbon and that sequesters carbon as it transitions from a first configuration to a second configuration. For example, FIG. 3A is a schematic illustration of a cultivation apparatus 200 deployed on a body of water W, in a first configuration, and FIG. 3B is a schematic illustration of the cultivation apparatus 200 in a second configuration different from the first configuration, according to an embodiment.

The cultivation apparatus 200 includes a substrate 210 seeded with a target product 230 (e.g., any one of the target products described herein). The substrate 210 includes a naturally occurring material (e.g., any of the naturally occurring materials described herein) that is formed into a porous block within which the target product 230 is seeded. The naturally occurring material may be formed into the block by pressing the naturally occurring material into a block via application of mechanical or hydraulic force, or via a thermoplastic process. The substrate 210 may include fertilizer, additives, growth promoters, or other substances infused therein, and may include binders or adhesives, as previously described.

The substrate 210 or assemblies of multiple substrates 210 may be configured to be deployed at a first location in a body of water (e.g., the location L1) in a first configuration. In the first configuration shown in FIG. 3A, the cultivation apparatus 200 has a first amount of buoyancy which is based on the combined buoyancy of the substrate 210 and the target product 230. As previously described, the substrate 210 may be positively buoyant and the target product 230 may be negatively buoyant or may become negatively buoyant as the target product 230 matures. However, in the first configuration, a relatively small biomass of the target product 230 is such that a magnitude of the negative buoyancy of the target product 230 is less than a magnitude of the positive buoyancy of the substrate 210. As such, the cultivation apparatus 200 has a buoyancy that is greater than a threshold buoyancy causing the cultivation apparatus 200 to float on the body of water W in the first configuration.

As the target product 230 grows within the substate 210, it absorbs, captures, and/or sequesters carbon while accumulating biomass. Once a threshold amount of biomass is accumulated, the cultivation apparatus 200 transitions into the second configuration in which the negative buoyancy of the target product 230 overcomes the positive buoyancy of the substrate 210 causing the buoyancy of the cultivation apparatus 200 to become less than the threshold buoyancy. This causes the cultivation apparatus 200 to sink below the surface of the body of water W as shown in FIG. 3B, thereby sequestering carbon from the atmosphere that is captured or absorbed by the target product by trapping it within the body of water W (e.g., below the surface carbon cycles), and is in addition to the CO₂ sequestered through the formation, transformation, and/or dissolution of the substrate and/or coatings, binders, etc. thereof. Moreover, the cultivation apparatus 200 may travel passively under natural water currents from the first location to a second location in the body of water (e.g., the second location L2) such as the deep ocean such that the sequestered carbon is transferred from the fast to the slow carbon cycle.

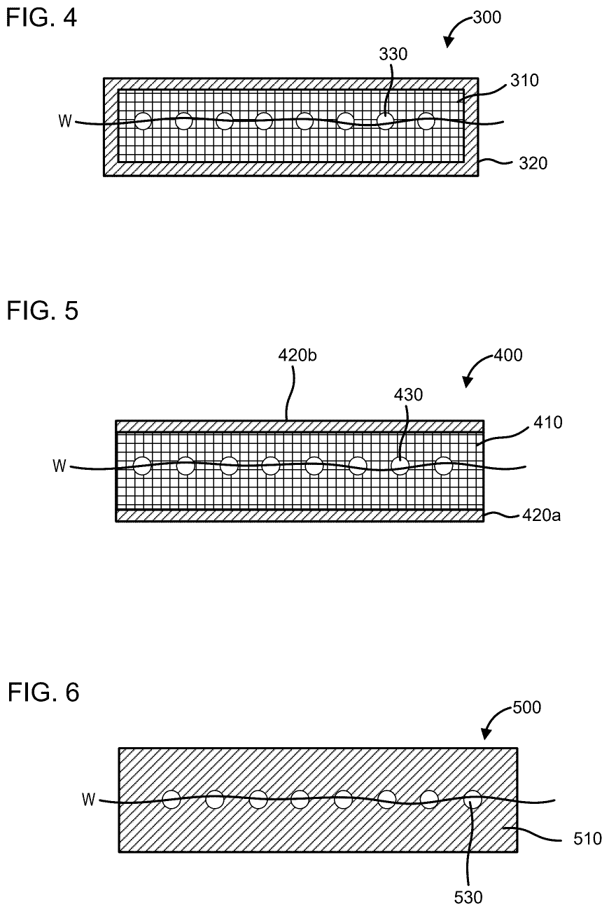

FIG. 4 is a schematic illustration of a cultivation apparatus 300 for growing a target product 330 (e.g., any of the target products described herein) and sequestering carbon that is deployed in a body of water W, according to an embodiment. The cultivation apparatus 300 includes a substrate 310 and a coating 320 formed form a carbonaceous material disposed on or around the substrate 310. In some embodiments, the substrate 310 may be formed from a naturally occurring material, for example, any of the naturally occurring materials described herein with respect to FIG. 1. The coating 320 is disposed around the substrate 310. In some embodiments, the coating 320 includes CaCO₃. In some embodiments, the coating 320 may include an aggregate fraction, a silicic fraction, a metal fraction, binders, accelerants, additives, catalysts, and/or any other material, as previously described herein. While the target product 330 is shown as seeded in the substrate 310, in some embodiments, the target product 330 may be additionally, or alternatively, seeded in the coating 320. Moreover, the coating 320 may also be infused into the product, and/or may coat the target product 330 (e.g., to promote adhesion of target product 330, and/or provide nutrients and/or other supplementary materials to the target product 330). While shown as being a rectangular block, in other embodiments, the substrate 310 may have any suitable shape, for example, square, ovoid, circular, polygonal, asymmetric, irregular, etc. The coating 320 may be configured to transition from a first configuration to a second configuration to adjust a buoyancy of the seeded substrate, and/or to sequester carbon, as previously described herein.

FIG. 5 is schematic illustration of a cultivation apparatus 400, according to an embodiment. The cultivation apparatus 400 includes a substrate 410 that is seeded with a target product 430 (e.g., any of the target products described herein) and is suspended in a body of water W. Different from the cultivation apparatus 300, the cultivation apparatus 400 includes a first coating 420a disposed on a first side of the substrate 410 and a second coating 420b disposed on a second side of the substrate 410 that may be opposite the first side. The first coating 420a and the second coating 420b may be formed from similar or different material(s) such as any of the materials described herein with respect to FIG. 1. In some embodiments, the first coating 420a may have first density that is greater than a second density of the second coating 420b. The higher density of the first coating 420a may cause the cultivation apparatus 400 to orient such that the first coating 420a (higher density) is below the surface of the body of water W, while the second coating 420b (lower density) is above the surface of the body of water W, at least when the cultivation apparatus 400 is initially deployed in the body of water. Thus, the first coating 420a and the second coating 420b may cause the cultivation apparatus 400 to be oriented in a preferred orientation in the body of water W.

FIG. 6 is a schematic illustration of a cultivation apparatus 500, according to an embodiment. The cultivation apparatus 500 includes a substrate 510 embedded with a target product 530 and floating on a body of water W. However, different from the substrates 310 and 410, the substrate 510 is formed from a carbonaceous material (e.g., any of the carbonaceous materials described herein), instead of just having a coating formed the carbonaceous material. In some embodiments, the target product 530 may sequester carbon as it grows, as previously described. In some embodiments, the substrate 510 may also be configured to sequester carbon (e.g., in addition to the carbon sequestration by the target product 530), as previously described. In some embodiments, the target product 530 may be excluded such that carbon sequestration and/or mitigation is provided by the substrate 510 (e.g., formed from a frozen alkaline fluid).

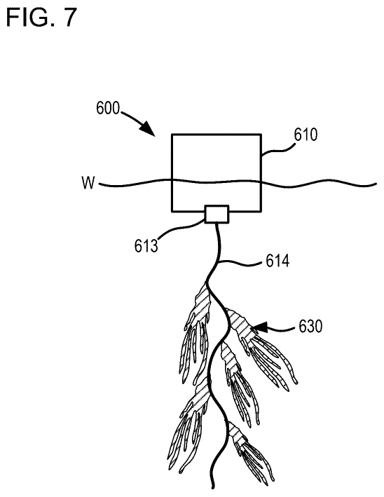

FIG. 7 is a schematic illustration of a cultivation apparatus 600, according to an embodiment. In some implementations, the cultivation apparatus 600 can be used to cultivate one or more target products such as, for example, one or more macroalgae species and/or the like, or any other target product described herein. In some implementations, the cultivation apparatus 600 or any of the substrates or cultivation apparatus described herein (e.g., the cultivation apparatus 200, 300, 400, 500) can be included in a deployment of tens, hundreds, thousands, tens of thousands, hundreds of thousands, or more cultivation apparatus. Each of the cultivation apparatus 600 (or any other cultivation apparatus described herein) in such a deployment may be seeded with and/or may have attached thereto one or more target products.

As described in detail herein, the deployment of cultivation apparatus 600 can occur at any suitable geographical location on or in any suitable body of water. As shown in FIG. 7, the cultivation apparatus 600 includes a first member 610, a second member 614, and an intermediate member 613 configured to reversibly couple the first member 610 to the second member 614. The cultivation apparatus 600 and/or the first, second, and intermediate members thereof, can be any suitable shape, size, and/or configuration. In some embodiments, for example, the cultivation apparatus 600 can be substantially similar to any of the cultivation apparatus (also referred to as “microfarms”) described in detail in the '315 patent incorporated by reference above. The cultivation apparatus 600 can differ, however, with the inclusion of one or more coating that includes any of the carbonaceous materials described herein, which may be used to form at least portions of the cultivation apparatus 600.

In some embodiments, the cultivation apparatus 600 can be arranged in a modular configuration in which one or more portions of the first member 610, the second member 614, and/or the intermediate member 613 can be mechanically coupled to collectively form the cultivation apparatus 600. For example, in some implementations, a second member 614 can be seeded with, be coupled to, and/or or attached to one or more target products (or a target product can be attached to the second member 614) at a delivery and/or deployment system. In such implementations, the one or more portions of the cultivation apparatus 600 can be loaded into the delivery and/or deployment system and/or a component thereof, transported to a deployment location, assembled (e.g., the first member 610, the second member 614, and the intermediate member 613 can be at least temporarily coupled) on the delivery and/or deployment system as the delivery and/or deployment system approaches and/or is at the deployment location, and then deployed into a body of water at or near the deployment location. In some embodiments, the second members 614 may include, or may be coated with any of the coatings described herein, for example, to promote adhesion of the target product 630, and/or provide nutrients and/or other supplementary materials to the target product 630 to support growth and the accumulation of biomass.

The first member 610 of the cultivation apparatus 600 can be any suitable shape, size, and/or configuration. In some embodiments, the first member 610 can include the substrate or cultivation apparatus 200, 300, 400, 500, or any other substrate or cultivation apparatus described herein. For example, in some embodiments, the first member 610 of the cultivation apparatus 600 can include and/or can form a growth substrate or the like configured to be seeded with and/or otherwise receive a target product such as one or more species of macroalgae gametophytes and/or sporophytes, as previously described herein. In some embodiments, the first member 610 can be configured to provide buoyancy to the various components of the cultivation apparatus 600 (with or without being seeded with a target product), allowing the apparatus 600 to float on a surface at least temporarily, or at a desired depth of the body of water W in which it is deployed. In some implementations, the first member 610 can be retrieved after a predetermined time and/or after a desired amount of target product growth or accumulation. In other implementations, the first member 610 can be configured to sink after a predetermined time and/or after a desired amount of target product growth or accumulation.

In some embodiments, the first member 610, which can also be referred to as a “substrate” or a “buoy” or any other selectively buoyant member, may be formed from a naturally occurring material, for example, any of the naturally occurring materials described herein. In some embodiments, at least a portion of the first member 610 may be coated with a coating formed from a carbonaceous material, or may be formed from the carbonaceous material, as described herein. In some embodiments, the first member 610 (e.g., in the form of hollow block) may include a mechanical, chemical, and/or biological timer/valve configured to release gas contained therein after a predetermined time (e.g., a time associated with and/or allowing for a desired amount of target product growth and/or accumulation), thereby reducing the buoyancy of the first member 610. In some embodiments, the first member 610 (e.g., any of the cultivation apparatus 200, 300, 400, 500) or at least a portion thereof can be configured to partially or completely degrade and/or decompose after a threshold period of being deployed (e.g., in or on an ocean, etc.) and/or in response to or after the cultivation apparatus 600 sinking to the sea/ocean bottom. In some implementations, the first member 610 can release a chemical and/or biological payload(s) such as alkaline fluids and/or the like into the surface ocean, which alone or in combination with or otherwise in support of target product accumulation can result in carbon sequestration.

In some embodiments, the first member 610 can include one or more portions that can degrade and/or decompose at different rates and/or at variable rates in response to environmental conditions. In some embodiments, the first member 610 can include a sealing member at least temporarily coupled to and/or at least temporarily disposed in the first member 610. In some implementations, the sealing member can be degradable, and/or automatically or manually decoupleable from the first member 610, thereby allowing the air and/or other gases contained therein to escape, and/or allow water to enter the first member 610. As such, the first member 610 (and thus, the cultivation apparatus 600) can be positively buoyant when initially deployed, allowed to float for a predetermined and/or threshold time after being deployed, and then allowed to sink as a target product seeded on or attached to the cultivation apparatus 600 grows and obtains biomass, as described in detail herein as well as in the '315 patent.

The second member 614 of the cultivation apparatus 600 can be any suitable shape, size, and/or configuration. The second member 614 can be coupled to the first member 610 and/or the intermediate member 613 (e.g., at a desired deployment location). In some embodiments, the second member 614 can be similar to and/or substantially the same as any of the second members of the cultivation apparatuses described in the '315 patent. For example, in some embodiments, the second member 614 can be one or more seeding lines, longlines, ropes, and/or the like. In some embodiments, the second member 614 can be similar to any of the substrates and/or can be formed from any of the naturally occurring materials described herein. In some embodiments, the second member 614 can include optional weight(s) such as metallic rings, mineralized layers, and/or the like (not shown) to provide negative buoyancy of and/or associated with the second member 614.

In some implementations, the second member 614 may be configured to receive one or more species of a target product 630 such as one or more species of macroalgae gametophytes and/or sporophytes, or any other target product described herein. For example, one or more portions and/or surfaces of the second member 614 can be formed of, include, and/or be coupled to a growth substrate (not shown), can be formed of any of the naturally occurring materials described herein, and/or can be included any of the coatings described herein, which in turn, is infused with a growth substrate, nutrients, fertilizers, binders, additives, pH-adjusting ions or buffers, and/or the like configured to facilitate seeding, attachment, and/or growth of a target product 630, as described above.

The intermediate member 613 of the cultivation apparatus 600 can be any suitable shape, size, and/or configuration. In some embodiments, the intermediate member 613 can be similar to and/or substantially the same as any of the intermediate members of the cultivation apparatuses described in the '315 patent. For example, in some embodiments, the intermediate member 613 can be similar, at least in part, to the first member 610 and/or second member 614. The intermediate member 613 is configured to couple at least temporarily the first member 610 to the second member 614. For example, one or more portions of the intermediate member 613 can be and/or can include an adhesive, glue, paste, cement, etc., one or more mechanical linkages such as ring(s), shackle(s), swivel(s), joint(s), and/or the like; one or more anchor points such as tie knot(s), thimble kit(s), hook(s), and/or the like; and/or any other suitable coupling.

In some embodiments, the intermediate member 613 can be formed of a degradable material, a compostable co-polyester, a cellulose-based material, any of the naturally occurring materials described herein, and/or the like. For example, the intermediate member 613 can be formed of and/or can include polyglycolide, polylactide, polyhydroxybutyrate, chitosan, hyaluronic acid, poly(lactic-co-glycolic), poly(caprolactone), polyhydroxyalkanoate, ECOFLEX®, ECOVIO®, and/or any other ocean compatible material(s) and/or combinations thereof. In some embodiments, the intermediate member 613 can be formed of any of the materials and/or combination of materials described, for example, in the '315 patent. In some embodiments, the intermediate member 613 may be formed from a naturally occurring material (e.g., any of the naturally occurring materials described herein). While examples of materials (e.g., degradable and/or compostable materials) are listed, it should be understood that other materials are possible, and the materials are not intended to be limited to those stated and/or referenced herein.

As described above with reference to the first member 610, the intermediate member 613 can be configured to degrade after a threshold or predetermined time of being deployed. In some implementations, the degrading of the intermediate member 613 can allow and/or can result in a decoupling of the first member 612 from the second member 614. In some embodiments, the intermediate member 613 can be configured to degrade after a desired amount of growth or accumulation of the target product 630 attached to the second member 614, as described above. In some embodiments, the intermediate member 613 can be configured to degrade under predetermined environmental conditions including but not limited to temperature, pressure, exposure to UV and/or visible light, and/or the like.

As described above, in some implementations, the first member 610 can be positively buoyant, while the second member 614 can be negatively buoyant and/or the target product 630 attached to the second member 614 can be negatively buoyant. Thus, when the intermediate member 613 decouples the first member 610 from the second member 614 (e.g., as a result of degrading or as a result of a mechanical decoupling), the first member 610 can float at or on a surface of the ocean, while the second member 614 and the target product 630 attached thereto can sink to the bottom or floor of the body of water (e.g., seafloor, ocean floor, etc.). The sinking of the second member 614 and the target product 630 attached thereto effectively sequesters an amount of carbon associated with and/or captured by the target product 630 and/or by the coating, and may also mitigate ocean acidification due to dissolution of the carbonaceous coating into the body of water W, as previously described herein.

In some embodiments, the second member 614 can be formed from the naturally occurring material, and may include the coating, or be formed form the carbonaceous material described herein, and may naturally degrade (e.g., after sinking). In some embodiments, the first member 610 that is formed from the naturally occurring material and/or the carbonaceous material, and may also be naturally degradable, or configured to degrade and/or otherwise decompose on the surface of the water or can be configured to degrade and sink to the bottom or floor of the body of water. In some embodiments, the first member 610 may degrade at a slower rate than the intermediate member 613 such that the degradation or otherwise decomposition of the intermediate member 613 causes detachment and sinking of the second member 614 and thereby, the target product 630.

In some embodiments, the cultivation apparatus 600 and/or one or more components thereof (e.g., the first member 610) can include and/or can be coupled to device(s) configured to sense, detect, and/or monitor growth of the target product 630, biomass generation, biomass yield, environmental characteristics or data, and/or any other data associated with a deployment of one or more cultivation apparatus. For example, in some embodiments, the cultivation apparatus 600 can include one or more sensors, cameras (e.g., underwater cameras, fluorometers, and/or other imaging or optical sensing technologies), tracking devices (e.g., a Global Positioning System (GPS) tracking device, Radio-Frequency Identification (RFID) devices, and/or the like), remote sensing devices, telemetry devices, communication devices, and/or any other suitable device such as any of those described in the '315 patent, the '681 application, and/or the ‘746 PCT.

In some implementations, including such device(s) in or coupling such device(s) to the buoyant first member 610 can allow the retrieval of the first member 610 and device(s) after, for example, the second member 614 has been decoupled from the first member 610. In such implementations, the first member 610 can be formed from any of the naturally occurring materials described herein and may also include any of the coating describe herein, but can be treated and/or otherwise configured to delay, reduce, and/or substantially prevent degradation, thereby allowing retrieval of the first member 610 (e.g., after being decoupled from the second member 614). As such, data associated with and/or collected at or by the cultivation apparatus 600 can be aggregated, analyzed, calculated, processed, etc. to allow for a determination, estimation, and/or prediction of, for example, historical or current target product growth or growth rates, biomass production, biomass yield, sinking rate(s), location(s) of a deployment, dispersion of a deployment, environmental conditions in an area corresponding to a deployment, estimated travel distance or estimated travel time to second location, and/or any other desired information associated with the cultivation apparatus 600 and/or a deployment of any number of cultivation apparatus. Moreover, in some implementations, such information can be used and/or can otherwise inform one or more predictions and/or quantifications associated with carbon capture and/or sequestration rates, quantities, capacities, and/or the like, as described in detail in the '315 patent, the ‘339 PCT, and/or the '681 application.

In some embodiments, the data collected by such devices may be wireless transmitted to remote data collection centers, for example, located on shore, or on boats, buoys, or drones floating in proximity of the location on the body of the water where aggregates or arrays of the cultivation apparatus 600 are deployed. In such embodiments, the device(s) may also be formed form biocompatible materials, such that device(s) sink into the body of water with the cultivation apparatus, and can eventually degrade or decompose in the body of water, as described in the ‘746 PCT.

It is important to note that the construction and arrangement of the various embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the any of the teachings and/or advantages of the subject matter described herein. Other substitutions, modifications, changes, and/or omissions may also be made in the design, operating conditions, and/or arrangement of the various embodiments without departing from the scope of the disclosure. Where schematics and/or embodiments described above indicate certain components arranged in certain orientations or positions, the arrangement of components may be modified.

While this specification contains many specific implementation details, these should not be construed as limitations on the scope of any embodiments or use of embodiments, or of what may be claimed, but rather as descriptions of features or aspects specific to particular implementations. Certain features and/or aspects described in this specification in the context of separate implementations can also be implemented in combination in a single implementation. Conversely, various features and/or aspects described in the context of a single implementation can also be implemented in multiple implementations separately or in any suitable subcombination. Moreover, although features may be described above as acting in certain combinations and even initially claimed as such, one or more features from a combination can in some cases be excised from the combination to define and/or form a subcombination or variation of a subcombination thereof.

Thus, while particular implementations have been described, other implementations are within the scope of the disclosure and the appended claims. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
deploying a carbon dioxide removal (CDR) payload at a first location in a body of water, the CDR payload being in a first configuration;
allowing the CDR payload to travel via natural water currents to a second location in the body of water, the CDR payload transitioning from a first configuration to a second configuration during travel from the first location to the second location to facilitate carbon dioxide sequestration; and
quantifying an amount of the carbon dioxide sequestration associated with the CDR payload transitioning from the first configuration to the second configuration.

2. The method of claim 1, further comprising:
defining a carbon credit based at least in part on the amount of the carbon dioxide sequestration associated with the CDR payload transitioning from the first configuration to the second configuration; and
selling the carbon credit on a carbon market.

3. The method of claim 1, wherein the CDR payload includes a substrate, the method further comprising:
forming the substrate from at least one of a naturally occurring material or an industrially produced material such that a buoyancy of the substrate in the first configuration is greater than a threshold buoyancy and a buoyancy of the substrate in the second configuration is less than the threshold buoyancy.

4. The method of claim 3, wherein the substrate includes a target product, the threshold buoyancy is based at least in part on a negative buoyancy of the target product after growing and accumulating biomass as the substrate is carried from the first location to the second configuration.

5. The method of claim 4, wherein the amount of carbon dioxide sequestration associated with the CDR payload is a sum of an amount of carbon dioxide sequestered as a result of the substrate transitioning from the first configuration to the second configuration and an amount of carbon dioxide sequestered as a result of the target product growing and accumulating biomass.

6. The method of claim 4, further comprising:
coating at least a portion of the substrate with a coating including an alkaline material, the coating configured to dissolve when the substrate is deployed in the body of water to cause the substrate to transition from the first configuration to the second configuration.

7. The method of claim 6, wherein the substrate is a first portion of the CDR payload and the coating is a second portion of the CDR payload, the second portion of the CDR payload includes at least one of a chemical CDR payload or a biological CDR payload configured to be released into the body of water as the substrate is carried via the natural water currents from the first location to the second location, and
wherein the amount of the carbon dioxide sequestration associated with the CDR payload is a sum of an amount of carbon dioxide sequestered as a result of the first portion of the CDR payload and an amount of carbon dioxide sequestered as a result of the second portion of the CDR payload.

8.-11. (canceled)

12. A method, comprising:
receiving a naturally occurring material from a naturally occurring material source;
forming the naturally occurring material into at least a portion of a carbon dioxide removal (CDR) payload;
deploying the CDR payload at a first location in a body of water;
allowing the CDR payload to transition from a first configuration to a second configuration as the CDR payload is carried by natural water currents from the first location in the body of water to a second location in the body of water;
capturing carbon dioxide via the CDR payload as a result of the CDR payload transitioning from the first configuration to the second configuration; and
quantifying an amount of the carbon dioxide sequestered by the CDR payload.

13. The method of claim 12, further comprising:
defining a carbon credit based at least in part on the amount of the carbon dioxide captured as the result of the CDR payload transitioning from the first configuration to the second configuration; and
selling the carbon credit on a carbon market.

14. The method of claim 12, wherein the CDR payload is a substrate, the method further comprising:
forming the substrate from at least one of a naturally occurring material or an industrially produced material such that a buoyancy of the substrate in the first configuration is greater than a threshold buoyancy and a buoyancy of the substrate in the second configuration is less than the threshold buoyancy.

15. The method of claim 14, wherein the substrate includes a target product, the threshold buoyancy is based at least in part on a negative buoyancy of the target product after growing and accumulating biomass as the substrate is carried from the first location to the second configuration.

16. The method of claim 14, further comprising:
coating at least a portion of the substrate with a coating including at least one of a carbonaceous material or an alkaline material, the coating configured to dissolve as the substrate is carried from the first location to the second location to cause the substrate to transition from the first configuration to the second configuration.

17. (canceled)

18. The method of claim 12, wherein the CDR payload includes an alkaline liquid, the method further comprising:
releasing the alkaline liquid into the body of water as the CDR payload is carried from the first location to the second location, the releasing of the alkaline liquid operable to at least partially neutralize acidification of the body of water or at least partially neutralize acidity released from a CDR payload.

19. A method, comprising:
receiving a naturally occurring material from a naturally occurring material source;
forming the naturally occurring material into a carbon dioxide removal (CDR) payload;
determining a target location in a body of water based at least in part on the CDR payload; and
executing at least one machine learning model, based at least in part on the CDR payload and the target location, to determine a deployment location for deploying the CDR payload in the body of water, the CDR payload configured to be carried by natural water currents from the deployment location to the target location, the CDR payload further configured to capture carbon dioxide as the CDR payload is carried from the deployment location to the target location.

20. The method of claim 19, further comprising:
quantifying an amount of the carbon dioxide captured by the CDR payload;
defining a carbon credit based at least in part on the amount of the carbon dioxide captured as the CDR payload is carried from the deployment location to the target location; and
selling the carbon credit on a carbon market.

21. The method of claim 19, wherein the target location is determined based at least in part on an estimated travel time and a predicted trajectory of the CDR payload through the body of water as the CDR payload is carried from the deployment location to the target location, and
wherein the deployment location is determined based at least in part on (i) an estimated travel time and a predicted trajectory of the CDR payload through the body of water as the CDR payload is carried from the deployment location to the target location and (ii) at least one of environmental conditions, chemistry of the body of water, regions of fish or marine mammal migration, or shipping traffic along the predicted trajectory.

22.-23. (canceled)

24. The method of claim 19, wherein the CDR payload includes a substrate comprising terrestrial biomass, the substrate configured to transition from a first configuration to second configuration as the CDR payload is carried from the deployment location to the target location, the method further comprising:
forming the substrate such that a buoyancy of the CDR payload before the substrate transitions to the second configuration is greater than a threshold buoyancy and the buoyancy of the CDR payload when the substrate is in the second configuration is less than the threshold buoyancy; and
configuring the CDR payload to sink to at a predetermined depth in the body of water at the target location when the substrate is in the second configuration to sequester the carbon dioxide captured by the CDR payload.

25. (canceled)

26. The method of claim 24, wherein the CDR payload includes a target product attached to the substrate, the threshold buoyancy being based at least in part on a negative buoyancy of the target product after growing and accumulating biomass as the CDR payload is carried from the deployment location to the target location, and
wherein an amount of the carbon dioxide sequestered as a result of the CDR payload sinking to the predetermined depth in the body of water is a sum of an amount of carbon dioxide captured as a result of the substrate transitioning from the first configuration to the second configuration and an amount of carbon dioxide captured as a result of the target product growing and accumulating biomass.

27. (canceled)

28. The method of claim 26, further comprising:
coating at least a portion of the substrate with a coating including at least a carbonaceous material or an alkaline material; and
configuring the coating to dissolve as the as the CDR payload is carried from the deployment location to the target location.

29. The method of claim 28, wherein the coating further includes at least one of nutrients, fertilizers, or additives configured to be released in response to the coating dissolving to support the target product growing and accumulating biomass.

30. (canceled)
